(19) United States
(12) Patent Application Publication
(10) Pub. No.: US 2024/0414195 A1
(43) Pub. Date: Dec. 12, 2024

(54) TOPOLOGICAL CO-RELATION

(71) Applicant: Palo Alto Networks, Inc., Santa Clara, CA (US)

(72) Inventors: Ramanathan Lakshmikanthan, Santa Clara, CA (US); Dinesh Ranjit, Milpitas, CA (US)

(21) Appl. No.: 18/429,177

(22) Filed: Jan. 31, 2024

Related U.S. Application Data
(60) Provisional application No. 63/459,494, filed on Apr. 14, 2023.
(60) Provisional application No. 63/459,492, filed on Apr. 14, 2023.
(60) Provisional application No. 63/459,500, filed on Apr. 14, 2023.

(51) Int. Cl. H04L 9/40

(52) U.S. Cl. CPC H04L 63/145; H04L 63/104; H04L 63/1425

(57) ABSTRACT

Techniques for providing a topological co-relation are disclosed. In some embodiments, a system/process/computer program product for providing a topological co-relation includes deriving hop-by-hop metrics for a network topology and a plurality of events for a cloud-based security service associated with access to an application over a network for a user or a group of users, wherein the network topology is monitored dynamically; correlating the derived hop-by-hop metrics and the plurality of events on a plurality of dimensions to facilitate automatically determining a root cause of an issue associated with the access to the application over the network for the user or the group of users based on the plurality of events; and performing a remediation response based on the root cause of the issue associated with the access to the application over the network for the user or the group of users based on the plurality of events.

### CROSS REFERENCE TO OTHER APPLICATIONS

This application claims priority to U.S. Provisional Patent Application No. 63/459,494 entitled APPLICATION ACCESS ANALYZER filed Apr. 14, 2023, U.S. Provisional Patent Application No. 63/459,492 entitled SECURITY POLICY ANALYSIS-DEVOPS APPROACH filed Apr. 14, 2023, and U.S. Provisional Patent Application No. 63/459,500 entitled TOPOLOGICAL CO-RELATION filed Apr. 14, 2023, all of which are incorporated herein by reference for all purposes.

### BACKGROUND OF THE INVENTION

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

### BRIEF DESCRIPTION OF THE DRAWINGS

Various embodiments of the invention are disclosed in the following detailed description and the accompanying drawings.

FIG. 1 illustrates an example of an environment in which malicious applications (“malware”) are detected and prevented from causing harm.

FIG. 2A illustrates an embodiment of a data appliance.

FIG. 2B is a functional diagram of logical components of an embodiment of a data appliance.

FIG. 3 illustrates an example of logical components that can be included in a system for analyzing samples.

FIG. 4A is an overview of the AIOPs for a Secure Access Service Edge (SASE) solution in accordance with some embodiments.

FIG. 4B illustrates an example use case for mobile users not being able to connect to a corporate network due to authentication issues.

FIG. 4C illustrates an example use case for reducing Mean Time To Detect (MTTD)/Mean Time To Resolve (MTTR) for access to SaaS/Private Apps using AIOPs for Secure Access Service Edge (SASE) in accordance with some embodiments.

FIG. 5A illustrates an AIOPs for SASE architecture to facilitate topological co-relation in accordance with some embodiments.

FIG. 5B illustrates an alert engine in accordance with some embodiments.

FIG. 5C illustrates an example relationship between various entities that is automatically generated and used for correlation and PRC in accordance with some embodiments.

FIG. 5D illustrates a Correlation and Prisma Controller Engine (CPE) in accordance with some embodiments.

FIG. 5E illustrates an example data model for the AIOPs platform in accordance with some embodiments.

FIG. 6 illustrates an ML pipelines architecture for an AIOPs for SASE solution to facilitate topological co-relation in accordance with some embodiments.

FIG. 7A illustrates an example use case for a significant drop in authenticated users detection in accordance with some embodiments.

FIG. 7B illustrates an example use case for a service connection cloud node anomaly detection in accordance with some embodiments.

FIGS. 8A-8C illustrate processes for performing correlation for an AIOPs SASE solution to facilitate topological co-relation techniques in accordance with some embodiments.

FIG. 9 is a flow diagram of a process for providing a topological co-relation in accordance with some embodiments.

FIG. 10 is another flow diagram of a process for providing a topological co-relation in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as one or more software applications on various types of devices, such as computer servers, gateways, network/routing devices (e.g., network routers), and data appliances (e.g., security appliances or other types of special purpose devices), and in various implementations, certain operations can be implemented in special purpose hardware, such as an ASIC or FPGA.

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets-using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)) as well as CN Series container next generation firewalls. For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

### Overview of Techniques for Topological Co-Relation

Generally, existing Information Technology (IT) operations have to go through thousands to millions of logs and a multitude of devices in enterprise infrastructures to identify application connectivity issues for users or groups of users. Troubleshooting and debugging connectivity issues typically require domain knowledge expertise, such as network architecture, routing/switching, server configuration, understanding of complex network security policies, and vendor specific Operating System (OS) and Command Line Interface (CLI) knowledge. As such, this significantly increases the person hours and mean time to detect and resolve the application connectivity issues.

For example, multiple network and security elements can often generate events/alerts that are anomalous from their vantage point, creating alert storms for Information Technology (IT). IT typically does not have adequate visibility into the actual impact when a downtime issue occurs for an enterprise (e.g., viewing network topology as a static distance). As such, IT personnel are challenged with isolating the problem from multiple symptoms indicated by potentially many events/alerts (e.g., resulting in higher false positives). IT personnel then must manually correlate events across different monitoring tools to attempt to identify the root cause of the issue, which is both labor intensive and time consuming as well as yielding limited correlations. This technology problem is generic to heterogeneous network and security stacks (e.g., and while it is applicable to security stacks it is also generally applicable to heterogeneous network environments, and as such, is relevant to IT helpdesk, NetOps, Network and Security admins, as well as to SASE implementations and technical support teams).

Accordingly, new and improved solutions that facilitate topological co-relation are disclosed with respect to various embodiments.

In some embodiments, new and improved topological co-relation solutions (e.g., for SASE service providers) are disclosed. Generally, event correlation for application and network access (e.g., access, availability, and/or performance, such as for a SaaS/Private App and/or a SASE service) is based on temporal and relationship as a dependency. For example, event correlation can be used to troubleshoot a tunnel over an interface, such as determining the potential cause when the interface goes down. However, existing event correlation solutions typically look at dependency and topological relationship as static distances. In contrast, the disclosed topological co-relation solution analyzes such network topology as a dynamic state, derived via hop-by-hop metrics and events, which can happen on any of the hops. Specifically, the disclosed topological co-relation solutions can utilize dynamic state, such as hop-by-hop metrics and events, which can happen on any of the hops. More specifically, the disclosed topological co-relation solutions can use both static information and the derived dynamic state based on node embeddings to correlate events. As a result, such events can then be correlated to isolate the symptoms from the problem and enable rapid root cause identification, such as will be further described below with respect to various embodiments.

Specifically, multiple network and security elements in the network generate events/alerts that the disclosed topological co-relation solution can effectively and efficiently correlate to suppress and aggregate to reduce noise and facilitate root cause detection. For example, the disclosed topological co-relation solution can provide causal information to isolate problems from symptoms enabling automated remediation that reduces time and person/IT hours to identify and resolve such technological issues in a complex network and security computing environment.

For example, is the disclosed solution can include an interface (e.g., a natural language (NL) query interface) to operators (e.g., IT/admin, such as for an IT help desk or other technology support personnel/users) to detect application reachability, connectivity, and access/permission issues, and which utilizes the disclosed techniques for topological co-relation, such as will be further described below with respect to various embodiments. The disclosed solution facilitates auto remediation. As an example, the solution provides an actionable verdict for a query submitted by the operator with comprehensive details of analysis and checks performed in different categories (e.g., distinct domains, including user/endpoint analysis, networking analysis, and security policy analysis, such as further described below). Specifically, the solution auto-discovers the network topology that a given user (e.g., the user(s) specified in the query) uses to access a given application (e.g., the SaaS/Private App specified in the query), analysis of operational state of an underlying network infrastructure, a user authentication analysis, checks on health and reachability of Domain Name System (DNS) and Authentication (Auth) servers that the user reaches before accessing the application, and security policy reasoning specific to the user or user groups for any access/permission issues.

Actionable verdict, root cause analysis, and pinpointing the problem significantly reduces the mean time to resolve application connectivity issues. Actionable verdict, root cause analysis and pinpointing the problem also saves the hassle and time operators would be required to otherwise perform by following a runbook/playbook and debugging multiple devices, which generally requires domain knowledge expertise.

As an example, the disclosed solution can be used for checking connectivity issues between one or more of the following: (1) a user, users, and/or a group of users to a SaaS application from mobile user gateways; (2) a user, users, and/or a group of users to a private application hosted on premise data centers or on a remote branch office; and (3) a user, users, and/or a group of users to remote site connectivity to a remote branch or data center.

In some embodiments, a system/process/computer program product for topological co-relation includes deriving hop-by-hop metrics for a network topology and a plurality of events for a cloud-based security service associated with access to an application over a network for a user or a group of users, wherein the network topology is monitored dynamically; correlating the derived hop-by-hop metrics and events on a plurality of dimensions to facilitate automatically determining a root cause of an issue associated with the access to the application over the network for a user or the group of users based on the plurality of events; and performing a remediation response based on the root cause of the issue associated with the access to the application over the network for the user or the group of users based on the plurality of events.

In one embodiment, the disclosed topological co-relation techniques can be used to determine comprehensive/multi-dimensional correlations, such as will be further described below.

In one embodiment, the disclosed topological co-relation techniques can be used to provide efficient and dynamic hop-by-hop analysis, such as will be further described below.

In one embodiment, the disclosed topological co-relation techniques can be used to facilitate greater noise suppression of duplicative/overlapping alerts, such as will be further described below.

In one embodiment, the disclosed topological co-relation techniques can be used to provide continuous live impact (e.g., blast radius) analysis, such as will be further described below.

In one embodiment, the disclosed topological co-relation techniques can be used to determine a root cause of an application access issue by correlating a plurality of data sources across a plurality of domains (e.g., providing enhanced visibility on health, connectivity, and usage for network, authentication, DNS, SaaS/Private App health, security policy configuration, etc.) using AI and ML as will be further described below.

In one embodiment, the disclosed topological co-relation techniques can be used to automatically detect an anomaly in network connectivity and/or a performance degradation (e.g., an anomaly in network connectivity and/or a performance degradation, such as based on configurable thresholds for determining reachability and/or performance degradation to given apps for a user(s) based on their location/access point) as will be further described below.

In one embodiment, the disclosed topological co-relation techniques can be used to generate human consumable/understandable and actionable verdict analysis that greatly reduces the mean time to detect and remediate application connectivity issues as will be further described below.

In one embodiment, the disclosed topological co-relation techniques can be used to perform an exhaustive analysis of various troubleshooting domains within a short period of time (e.g., a few minutes), which would otherwise typically require many hours to troubleshoot each domain, such as will be further described below.

In one embodiment, the disclosed topological co-relation techniques can be used to perform an analysis that includes identifying issues in a network infrastructure, customer network services, client connectivity issues, SaaS/private application (app) health and reachability issues as will be further described below. For example, the disclosed topological co-relation techniques can provide an actionable summary of each troubleshooting domain, and the operator does not need to have domain knowledge expertise to detect and remediate the issue(s).

In one embodiment, the disclosed topological co-relation techniques can be used to automatically discover (auto discover) a network topology that is used by a user to access the application and perform analysis for possible application access issues.

In one embodiment, the disclosed techniques can be used to provide a security posture evaluation by building a unified logical model of computation for security policies of the firewall.

In one embodiment, the disclosed topological co-relation can be used for managing and maintaining the track of network topology issues, configuration issues with networking, network services, and security policy, which can often be cumbersome and error prone, such as will be further described below. For example, the disclosed techniques can provide a comprehensive analysis of each of these domains with a convenient natural language (NL) query interface.

In one embodiment, the disclosed topological co-relation can be used to significantly reduce operational and support costs for enterprises and their users for accessing their SaaS/Private Apps.

In an example implementation, the disclosed topological co-relation is implemented as a Prisma AI Operations (AIOPs) platform that provides proactive service level management across customers globally and is designed for use by Network Operations Center (NOC) personnel supporting SASE customers, such as will be further described below. Specifically, Prisma AIOPs provide proactive monitoring, alerting, problem isolation, and playbook-driven remediation to provide SLA (MTTK/I, MTTR) as desired/required by customers.

In one embodiment, the disclosed Prisma AIOPs can provide AI/ML powered predictive analytics for network anomaly detection and capacity utilization to avoid outages, such as further described below.

In one embodiment, the disclosed Prisma AIOPs can provide a natural language (NL) interface for contextual troubleshooting and what-if analysis, such as further described below.

In one embodiment, the disclosed Prisma AIOPs can provide automated analysis of existing security policy(/ies) for best practice recommendations and/or to avoid sprawls and/or shadow security policies, such as further described below.

In one embodiment, the disclosed Prisma AIOPs can provide a sandboxing environment for security policy pre-change analysis to reduce change risks and strengthen an enterprise's security posture, such as further described below.

In one embodiment, the disclosed Prisma AIOPs can provide baselining and correlation of real-time and historical data/events from discrete sources for anomaly detection, root cause analysis (RCA), playbook-driven remediation, and fix verification, such as further described below.

In some embodiments, a system/process/computer program product for topological co-relation includes monitoring access to an application over a network; generating a baseline for monitored access to the application over the network for each of a plurality of dimensions; automatically forecasting a network metric for one or more of the plurality of dimensions; and generating an alert or a report with recommended configurations and/or remediation based on the forecast of the network metric for one or more of the plurality of dimensions.

In addition, network traffic patterns in different office/branch locations (e.g., for enterprise networks) can significantly vary in terms of numbers of users, user traffic access patterns, and usage. As such, the networks for the office/branch locations (e.g., sites for the enterprise) are generally configured with sufficient bandwidth to securely protect the traffic from the office/branch locations via firewalls of a security provider (e.g., cloud-based firewall solutions of the Secure Access Service Edge (SASE) security solution, such as the SASE solution that is commercially available from Palo Alto Networks, Inc. headquartered in Santa Clara, CA) to their respective application services (e.g., Software as a Service (SaaS) and/or Private Applications (Apps)). Generally, there are two fronts for ensuring that each of the office/branch locations has sufficient bandwidth to serve the users in the branch: (1) overlay capacity (e.g., how much of encrypted traffic is served by the firewalls); and (2) underlay capacity (e.g., how much of physical circuit capacity for the physical Internet connectivity exists from each of the office/branch locations). As such, for better provisioning of the user experience, customers generally utilize a long term forecast of bandwidth utilization per site to facilitate effective provisioning for additional firewall capacity as well as physical Internet connectivity capacity.

In addition, SASE service providers (e.g., also referred to as cloud SASE service providers) also generally plan and provision for the capacity of tunnels that connect multiple hops of the SASE fabric to provide sufficient connectivity across all tenants.

In some embodiments, machine learning (ML) prediction for capacity for SASE service providers is disclosed. For example, a forecast of bandwidth usage with a predetermined horizon (e.g., a one-month horizon) can utilize a cost optimized ML solution. Traditionally, an ML model can be built using existing algorithms with personalized models per site or per mesh connection of the SASE fabric that learns the site or mesh tunnel specific behavior and uses that to forecast the future usage. However, the number of such models can increase significantly over time, which makes the cost and maintenance of the ML model training and inference significantly high.

Accordingly, the disclosed ML prediction for capacity for SASE service providers is a new and improved ML solution that enables a cost optimized forecast of all sites/circuits using a single ML model. Specifically, a key feature or set of features is used to partition data within the ML model so that the ML model learns the different statistical distributions corresponding to different values of these features, without mixing them. In addition, the disclosed ML solution can learn and utilize correlations between different feature values, such as different branches, without reducing individual forecast accuracy and, in some cases, enhancing accuracy by accounting for correlations, such as will be further described below with respect to various embodiments.

Accordingly, new and improved security solutions that utilize topological co-relation are disclosed in accordance with some embodiments.

These and other embodiments and examples for topological co-relation will be further described below.

### Example System Environments for Topological Co-Relation

Accordingly, in some embodiments, the disclosed techniques include providing a security platform (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, such as PANOS executing on a virtual/physical NGFW solution commercially available from Palo Alto Networks, Inc. or another security platform/NFGW, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) configured to provide DPI capabilities (e.g., including stateful inspection) which, for example, can be provided in part or in whole as a SASE security solution, in which the cloud-based security solution (e.g., SASE) can be monitored using the disclosed techniques for an application access analyzer, as further described below.

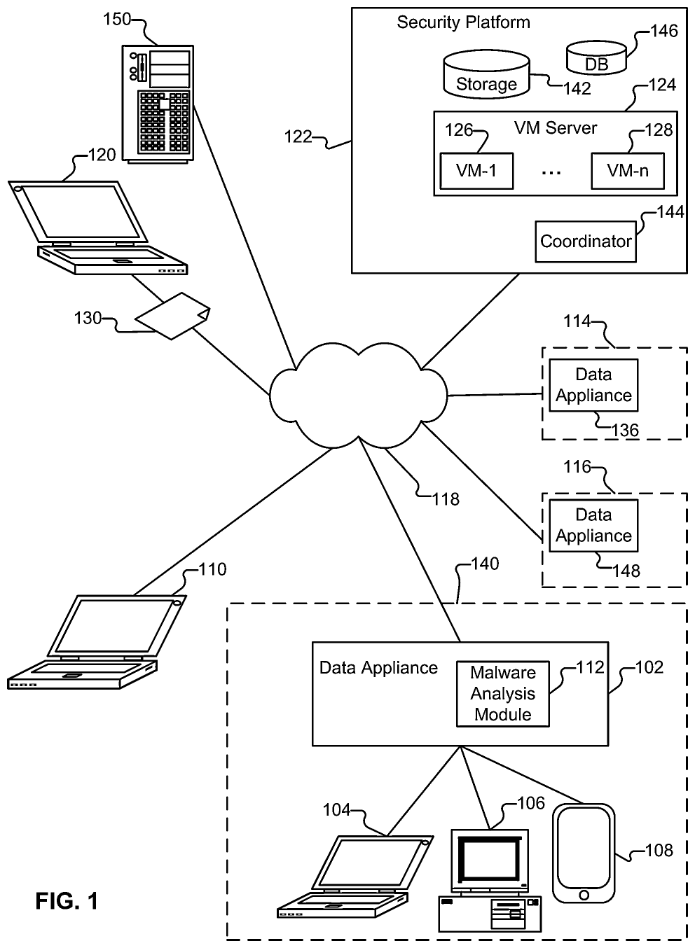

FIG. 1 illustrates an example of an environment in which malicious applications (“malware”) are detected and prevented from causing harm. As will be described in more detail below, malware classifications (e.g., as made by security platform 122) can be variously shared and/or refined among various entities included in the environment shown in FIG. 1. And, using techniques described herein, devices, such as endpoint client devices 104-110, can be protected from such malware (e.g., including previously unknown/new variants of malware, such as C2 malware).

“Malware” as used herein refers to an application that engages in behaviors, whether clandestinely or not (and whether illegal or not), of which a user does not approve/would not approve if fully informed. Examples of malware include ransomware, Trojans, viruses, rootkits, spyware, hacking tools, etc. One example of malware is a desktop/mobile application that encrypts a user's stored data (e.g., ransomware). Another example of malware is C2 malware, such as similarly described above. Other forms of malware (e.g., keyloggers) can also be detected/thwarted using the disclosed techniques for sample traffic based self-learning malware detection as will be further described herein.

Techniques described herein can be used in conjunction with a variety of platforms (e.g., servers, computing appliances, virtual/container environments, desktops, mobile devices, gaming platforms, embedded systems, etc.) and/or for automated detection of a variety of forms of malware (e.g., new and/or variants of malware, such as C2 malware, etc.). In the example environment shown in FIG. 1, client devices 104-108 are a laptop computer, a desktop computer, and a tablet (respectively) present in an enterprise network 140. Client device 110 is a laptop computer present outside of enterprise network 140.

Data appliance 102 is configured to enforce policies regarding communications between client devices, such as client devices 104 and 106, and nodes outside of enterprise network 140 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, web site content, files exchanged through instant messaging programs, and/or other file transfers. In some embodiments, data appliance 102 is also configured to enforce policies with respect to traffic that stays within enterprise network 140.

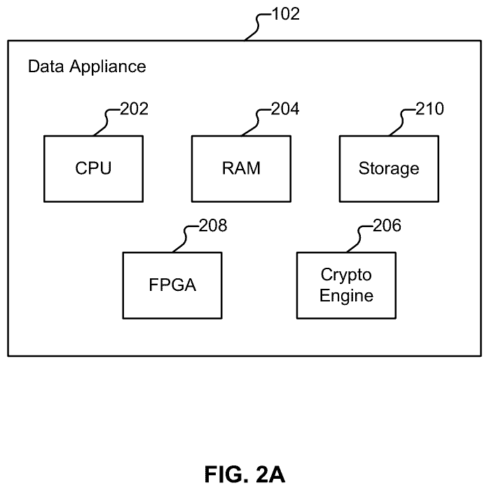

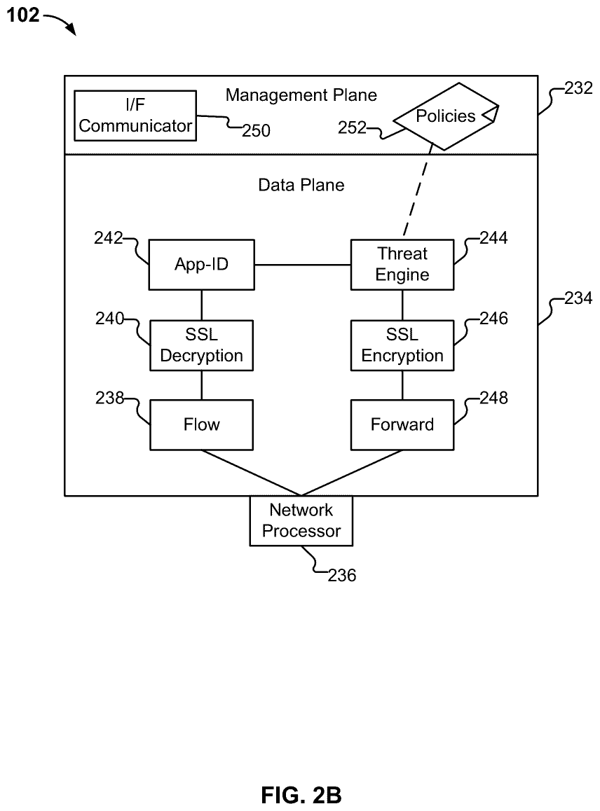

An embodiment of a data appliance is shown in FIG. 2A. The example shown is a representation of physical components that are included in data appliance 102, in various embodiments. Specifically, data appliance 102 includes a high-performance multi-core Central Processing Unit (CPU) 202 and Random Access Memory (RAM) 204. Data appliance 102 also includes a storage 210 (such as one or more hard disks or solid-state storage units). In various embodiments, data appliance 102 stores (whether in RAM 204, storage 210, and/or other appropriate locations) information used in monitoring enterprise network 140 and implementing disclosed techniques. Examples of such information include application identifiers, content identifiers, user identifiers, requested URLs, IP address mappings, policy and other configuration information, signatures, hostname/URL categorization information, malware profiles, and machine learning (ML) models (e.g., such as for sample traffic based self-learning malware detection). Data appliance 102 can also include one or more optional hardware accelerators. For example, data appliance 102 can include a cryptographic engine 206 configured to perform encryption and decryption operations, and one or more Field Programmable Gate Arrays (FPGAs) 208 configured to perform matching, act as network processors, and/or perform other tasks.

Functionality described herein as being performed by data appliance 102 can be provided/implemented in a variety of ways. For example, data appliance 102 can be a dedicated device or set of devices. The functionality provided by data appliance 102 can also be integrated into or executed as software on a general-purpose computer, a computer server, a gateway, and/or a network/routing device. In some embodiments, at least some services described as being provided by data appliance 102 are instead (or in addition) provided to a client device (e.g., client device 104 or client device 110) by software executing on the client device.

Whenever data appliance 102 is described as performing a task, a single component, a subset of components, or all components of data appliance 102 may cooperate to perform the task. Similarly, whenever a component of data appliance 102 is described as performing a task, a subcomponent may perform the task and/or the component may perform the task in conjunction with other components. In various embodiments, portions of data appliance 102 are provided by one or more third parties. Depending on factors such as the amount of computing resources available to data appliance 102, various logical components and/or features of data appliance 102 may be omitted and the techniques described herein adapted accordingly. Similarly, additional logical components/features can be included in embodiments of data appliance 102 as applicable. One example of a component included in data appliance 102 in various embodiments is an application identification engine which is configured to identify an application (e.g., using various application signatures for identifying applications based on packet flow analysis). For example, the application identification engine can determine what type of traffic a session involves, such as Web Browsing-Social Networking; Web Browsing-News; SSH; and so on.

FIG. 2B is a functional diagram of logical components of an embodiment of a data appliance. The example shown is a representation of logical components that can be included in data appliance 102 in various embodiments. Unless otherwise specified, various logical components of data appliance 102 are generally implementable in a variety of ways, including as a set of one or more scripts (e.g., written in Java, python, etc., as applicable).

As shown, data appliance 102 comprises a firewall, and includes a management plane 232 and a data plane 234. The management plane is responsible for managing user interactions, such as by providing a user interface for configuring policies and viewing log data. The data plane is responsible for managing data, such as by performing packet processing and session handling.

Network processor 236 is configured to receive packets from client devices, such as client device 108, and provide them to data plane 234 for processing. Whenever flow module 238 identifies packets as being part of a new session, it creates a new session flow. Subsequent packets will be identified as belonging to the session based on a flow lookup. If applicable, SSL decryption is applied by SSL decryption engine 240. Otherwise, processing by SSL decryption engine 240 is omitted. Decryption engine 240 can help data appliance 102 inspect and control SSL/TLS and SSH encrypted traffic, and thus help to stop threats that might otherwise remain hidden in encrypted traffic. Decryption engine 240 can also help prevent sensitive content from leaving enterprise network 140. Decryption can be controlled (e.g., enabled or disabled) selectively based on parameters such as: URL category, traffic source, traffic destination, user, user group, and port. In addition to decryption policies (e.g., that specify which sessions to decrypt), decryption profiles can be assigned to control various options for sessions controlled by the policy. For example, the use of specific cipher suites and encryption protocol versions can be required.

Application identification (APP-ID) engine 242 is configured to determine what type of traffic a session involves. As one example, application identification engine 242 can recognize a GET request in received data and conclude that the session requires an HTTP decoder. In some cases, such as a web browsing session, the identified application can change, and such changes will be noted by data appliance 102. For example, a user may initially browse to a corporate Wiki (classified based on the URL visited as “Web Browsing-Productivity”) and then subsequently browse to a social networking site (classified based on the URL visited as “Web Browsing-Social Networking”). Distinct types of protocols have corresponding decoders.

Based on the determination made by application identification engine 242, the packets are sent, by threat engine 244, to an appropriate decoder configured to assemble packets (which may be received out of order) into the correct order, perform tokenization, and extract out information. Threat engine 244 also performs signature matching to determine what should happen to the packet. As needed, SSL encryption engine 246 can re-encrypt decrypted data. Packets are forwarded using a forward module 248 for transmission (e.g., to a destination).

As also shown in FIG. 2B, policies 252 are received and stored in management plane 232. Policies can include one or more rules, which can be specified using domain and/or host/server names, and rules can apply one or more signatures or other matching criteria or heuristics, such as for security policy enforcement for subscriber/IP flows based on various extracted parameters/information from monitored session traffic flows. Example policies can include C2 malware detection policies using the disclosed techniques for sample traffic based self-learning malware detection. An interface (I/F) communicator 250 is provided for management communications (e.g., via (REST) APIs, messages, or network protocol communications or other communication mechanisms).

### Security Platform

Returning to FIG. 1, suppose a malicious individual (using system 120) has created malware 130, such as malware for a malicious web campaign (e.g., the malware can be delivered to endpoint devices of users via a compromised web site when the user visits/browses to the compromised web site or via a phishing attack, etc.). The malicious individual hopes that a client device, such as client device 104, will execute a copy of malware 130 to unpack the malware executable/payload, compromising the client device, and, e.g., causing the client device to become a bot in a botnet. The compromised client device can then be instructed to perform tasks (e.g., cryptocurrency mining, or participating in denial-of-service attacks) and to report information to an external entity, such as command and control (C2/C&C) server 150, as well as to receive instructions from C2 server 150, as applicable.

Suppose data appliance 102 has intercepted an email sent (e.g., by system 120) to a user, “Alice,” who operates client device 104. In this example, Alice receives the email and clicks on the link to a phishing/compromised site that could result in an attempted download of malware 130 by Alice's client device 104. However, in this example, data appliance 102 can perform the disclosed techniques for sample traffic based self-learning malware detection and block access from Alice's client device 104 to the packed malware content and to thereby preempt and prevent any such download of malware 130 to Alice's client device 104. As will be further described below, data appliance 102 performs the disclosed techniques for sample traffic based self-learning malware detection, such as further described below, to detect and block such malware 130 from harming Alice's client device 104.

In various embodiments, data appliance 102 is configured to work in cooperation with security platform 122. As one example, security platform 122 can provide to data appliance 102 a set of signatures of known-malicious files (e.g., as part of a subscription). If a signature for malware 130 is included in the set (e.g., an MD5 hash of malware 130), data appliance 102 can prevent the transmission of malware 130 to client device 104 accordingly (e.g., by detecting that an MD5 hash of the email attachment sent to client device 104 matches the MD5 hash of malware 130). Security platform 122 can also provide to data appliance 102 a list of known malicious domains and/or IP addresses, allowing data appliance 102 to block traffic between enterprise network 140 and C2 server 150 (e.g., where C&C server 150 is known to be malicious). The list of malicious domains (and/or IP addresses) can also help data appliance 102 determine when one of its nodes has been compromised. For example, if client device 104 attempts to contact C2 server 150, such attempt is a strong indicator that client 104 has been compromised by malware (and remedial actions should be taken accordingly, such as quarantining client device 104 from communicating with other nodes within enterprise network 140).

As will be described in more detail below, security platform 122 can also receive a copy of malware 130 from data appliance 102 to perform cloud-based security analysis for performing sample traffic based self-learning malware detection, and the malware verdict can be sent back to data appliance 102 for enforcing the security policy to thereby safeguard Alice's client device 104 from execution of malware 130 (e.g., to block malware 130 from access on client device 104).

A variety of actions can be taken by data appliance 102 if no signature for an attachment is found, in various embodiments. As a first example, data appliance 102 can fail-safe, by blocking transmission of any attachments not allow-listed as benign (e.g., not matching signatures of known good files). A drawback of this approach is that there may be many legitimate attachments unnecessarily blocked as potential malware when they are in fact benign. As a second example, data appliance 102 can fail-danger by allowing transmission of any attachments not block-listed as malicious (e.g., not matching signatures of known bad files). A drawback of this approach is that newly created malware (previously unseen by platform 122) will not be prevented from causing harm. As a third example, data appliance 102 can be configured to provide the file (e.g., malware 130) to security platform 122 for static/dynamic analysis, to determine whether it is malicious and/or to otherwise classify it.

Security platform 122 stores copies of received samples in storage 142 and analysis is commenced (or scheduled, as applicable). One example of storage 142 is an Apache Hadoop Cluster (HDFS). Results of analysis (and additional information pertaining to the applications) are stored in database 146. In the event an application is determined to be malicious, data appliances can be configured to automatically block the file download based on the analysis result. Further, a signature can be generated for the malware and distributed (e.g., to data appliances such as data appliances 102, 136, and 148) to automatically block future file transfer requests to download the file determined to be malicious.

In various embodiments, security platform 122 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 122 can be implemented across a scalable infrastructure comprising multiple such servers, solid state drives, and/or other applicable high-performance hardware. Security platform 122 can comprise several distributed components, including components provided by one or more third parties. For example, portions or all of security platform 122 can be implemented using the Amazon Elastic Compute Cloud (EC2) and/or Amazon Simple Storage Service (S3). Further, as with data appliance 102, whenever security platform 122 is referred to as performing a task, such as storing data or processing data, it is to be understood that a sub-component or multiple sub-components of security platform 122 (whether individually or in cooperation with third party components) may cooperate to perform that task. As one example, security platform 122 can optionally perform static/dynamic analysis in cooperation with one or more virtual machine (VM) servers, such as VM server 124.

An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 122 but may also be provided by a third party. As one example, the virtual machine server can rely on EC2, with the remainder portions of security platform 122 provided by dedicated hardware owned by and under the control of the operator of security platform 122. VM server 124 is configured to provide one or more virtual machines 126-128 for emulating client devices. The virtual machines can execute a variety of operating systems and/or versions thereof. Observed behaviors resulting from executing applications in the virtual machines are logged and analyzed (e.g., for indications that the application is malicious). In some embodiments, log analysis is performed by the VM server (e.g., VM server 124). In other embodiments, analysis is performed at least in part by other components of security platform 122, such as a coordinator 144.

In various embodiments, security platform 122 makes available results of its analysis of samples via a list of signatures (and/or other identifiers) to data appliance 102 as part of a subscription. For example, security platform 122 can periodically send a content package that identifies malware files, including for network traffic based heuristic IPS malware detection, etc. (e.g., daily, hourly, or some other interval, and/or based on an event configured by one or more policies). The subscription can cover the analysis of just those files intercepted by data appliance 102 and sent to security platform 122 by data appliance 102 and can also cover signatures of malware known to security platform 122.

In various embodiments, security platform 122 is configured to provide security services to a variety of entities in addition to (or, as applicable, instead of) an operator of data appliance 102. For example, other enterprises, having their own respective enterprise networks 114 and 116, and their own respective data appliances 136 and 148, can contract with the operator of security platform 122. Other types of entities can also make use of the services of security platform 122. For example, an Internet Service Provider (ISP) providing Internet service to client device 110 can contract with security platform 122 to analyze applications which client device 110 attempts to download. As another example, the owner of client device 110 can install software on client device 110 that communicates with security platform 122 (e.g., to receive content packages from security platform 122, use the received content packages to check attachments in accordance with techniques described herein, and transmit applications to security platform 122 for analysis).

### Analyzing Samples Using Static/Dynamic Analysis

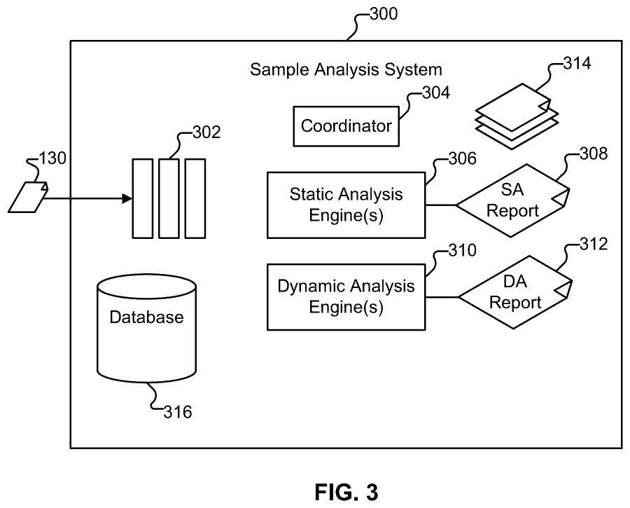

FIG. 3 illustrates an example of logical components that can be included in a system for analyzing samples. Analysis system 300 can be implemented using a single device. For example, the functionality of analysis system 300 can be implemented in a malware analysis module 112 incorporated into data appliance 102. Analysis system 300 can also be implemented, collectively, across multiple distinct devices. For example, the functionality of analysis system 300 can be provided by security platform 122.

In various embodiments, analysis system 300 makes use of lists, databases, or other collections of known safe content and/or known bad content (e.g., collectively shown in FIG. 3 as collection 314). Collection 314 can be obtained in a variety of ways, including via a subscription service (e.g., provided by a third party) and/or as a result of other processing (e.g., performed by data appliance 102 and/or security platform 122). Examples of information included in collection 314 are: URLs, domain names, and/or IP addresses of known malicious servers; URLs, domain names, and/or IP addresses of known safe servers; URLs, domain names, and/or IP addresses of known command and control (C2/C&C) domains; signatures, hashes, and/or other identifiers of known malicious applications; signatures, hashes, and/or other identifiers of known safe applications; signatures, hashes, and/or other identifiers of known malicious files (e.g., OS exploit files); signatures, hashes, and/or other identifiers of known safe libraries; and signatures, hashes, and/or other identifiers of known malicious libraries.

In various embodiments, when a new sample is received for analysis (e.g., an existing signature associated with the sample is not present in analysis system 300), it is added to queue 302. As shown in FIG. 3, application 130 is received by system 300 and added to queue 302.

Coordinator 304 monitors queue 302, and as resources (e.g., a static analysis worker) become available, coordinator 304 fetches a sample from queue 302 for processing (e.g., fetches a copy of malware 130). In particular, coordinator 304 first provides the sample to static analysis engine 306 for static analysis. In some embodiments, one or more static analysis engines are included within analysis system 300, where analysis system 300 is a single device. In other embodiments, static analysis is performed by a separate static analysis server that includes a plurality of workers (i.e., a plurality of instances of static analysis engine 306).

The static analysis engine obtains general information about the sample and includes it (along with heuristic and other information, as applicable) in a static analysis report 308. The report can be created by the static analysis engine, or by coordinator 304 (or by another appropriate component) which can be configured to receive the information from static analysis engine 306. As an example, static analysis of malware can include performing a signature-based analysis. In some embodiments, the collected information is stored in a database record for the sample (e.g., in database 316), instead of or in addition to a separate static analysis report 308 being created (i.e., portions of the database record form the report 308). In some embodiments, the static analysis engine also forms a verdict with respect to the application (e.g., “safe,” “suspicious,” or “malicious”). As one example, the verdict can be “malicious” if even one “malicious” static feature is present in the application (e.g., the application includes a hard link to a known malicious domain). As another example, points can be assigned to each of the features (e.g., based on severity if found; based on how reliable the feature is for predicting malice; etc.) and a verdict can be assigned by static analysis engine 306 (or coordinator 304, if applicable) based on the number of points associated with the static analysis results.

Once static analysis is completed, coordinator 304 locates an available dynamic analysis engine 310 to perform dynamic analysis on the application. As with static analysis engine 306, analysis system 300 can include one or more dynamic analysis engines directly. In other embodiments, dynamic analysis is performed by a separate dynamic analysis server that includes a plurality of workers (i.e., a plurality of instances of dynamic analysis engine 310).

Each dynamic analysis worker manages a virtual machine instance (e.g., emulation/sandbox analysis of samples for malware detection, such as the above-described C2 malware detection based on monitored network traffic activity). In some embodiments, results of static analysis (e.g., performed by static analysis engine 306), whether in report form (308) and/or as stored in database 316, or otherwise stored, are provided as input to dynamic analysis engine 310. For example, the static report information can be used to help select/customize the virtual machine instance used by dynamic analysis engine 310 (e.g., Microsoft Windows 7 SP 2 vs. Microsoft Windows 10 Enterprise, or iOS 11.0 vs. iOS 12.0). Where multiple virtual machine instances are executed at the same time, a single dynamic analysis engine can manage all of the instances, or multiple dynamic analysis engines can be used (e.g., with each managing its own virtual machine instance), as applicable. As will be explained in more detail below, during the dynamic portion of the analysis, actions taken by the application (including network activity) are analyzed.

In various embodiments, static analysis of a sample is omitted or is performed by a separate entity, as applicable. As one example, traditional static and/or dynamic analysis may be performed on files by a first entity. Once it is determined (e.g., by the first entity) that a given file is malicious, the file can be provided to a second entity (e.g., the operator of security platform 122) specifically for additional analysis with respect to the malware's use of network activity (e.g., by a dynamic analysis engine 310).

The environment used by analysis system 300 is instrumented/hooked such that behaviors observed while the application is executing are logged as they occur (e.g., using a customized kernel that supports hooking and logcat). Network traffic associated with the emulator is also captured (e.g., using pcap). The log/network data can be stored as a temporary file on analysis system 300, and can also be stored more permanently (e.g., using HDFS or another appropriate storage technology or combinations of technology, such as MongoDB). The dynamic analysis engine (or another appropriate component) can compare the connections made by the sample to lists of domains, IP addresses, etc. (314) and determine whether the sample has communicated (or attempted to communicate) with malicious entities.

As with the static analysis engine, the dynamic analysis engine stores the results of its analysis in database 316 in the record associated with the application being tested (and/or includes the results in report 312 as applicable). In some embodiments, the dynamic analysis engine also forms a verdict with respect to the application (e.g., “safe,” “suspicious,” or “malicious”). As one example, the verdict can be “malicious” if even one “malicious” action is taken by the application (e.g., an attempt to contact a known malicious domain is made, or an attempt to exfiltrate sensitive information is observed). As another example, points can be assigned to actions taken (e.g., based on severity if found; based on how reliable the action is for predicting malice; etc.) and a verdict can be assigned by dynamic analysis engine 310 (or coordinator 304, if applicable) based on the number of points associated with the dynamic analysis results. In some embodiments, a final verdict associated with the sample is made based on a combination of report 308 and report 312 (e.g., by coordinator 304).

### AIOPs for SASE Architecture to Facilitate Application Access Visibility

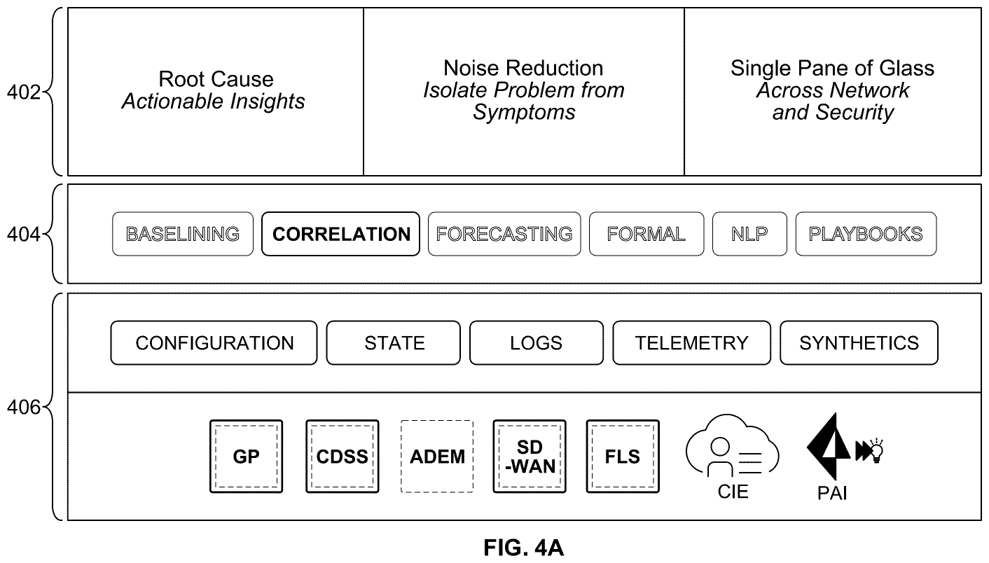

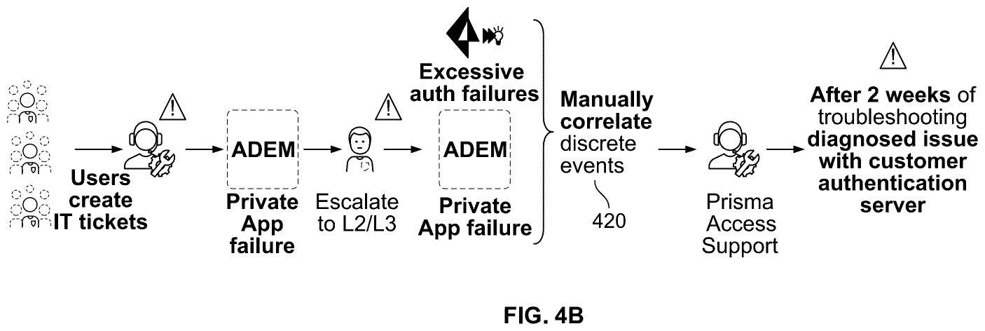

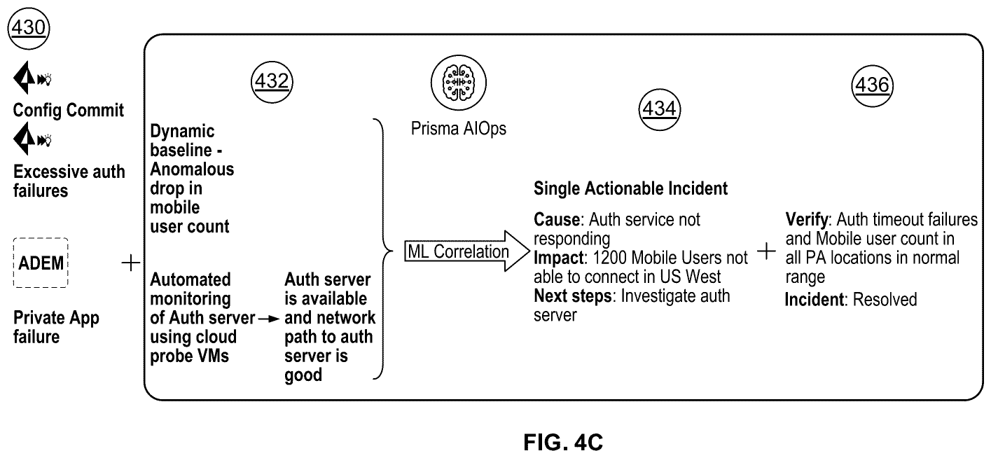

FIG. 4A is an overview of the AIOPs for a Secure Access Service Edge (SASE) solution in accordance with some embodiments. As shown in FIG. 4A, the disclosed AIOPs for SASE architecture can facilitate application access visibility including root cause analysis (e.g., actionable insights), and noise reduction (e.g., isolating problems from symptoms, such as for accessibility to a SaaS/Private App), using a single plane of glass (e.g., providing efficient visibility across networks and security solutions) as shown at 402 (e.g., in this example, the SASE solution is the commercially available Prisma Access SASE solution from Palo Alto Networks, Inc, headquartered in Santa Clara, CA and/or the disclosed techniques can similarly be provided for other SASE environments and commercially available solutions).

As shown at 404, the disclosed AIOPs for SASE architecture includes various technology components, including baselining, correlation, forecasting, formal analysis (e.g., of access permissions/security policies, etc.), natural language processing (NLP) for queries via a user interface (UI), and computational playbooks, such as will be further described below.

As shown at 406, the disclosed AIOPs for SASE architecture includes various data sources, including configuration information, state information, logs (e.g., firewall logs, etc.), telemetry data, and synthetic data (e.g., from various network and security solution sources, such as the GlobalProtect(GP) VPN solution that is commercially available from Palo Alto Networks, Inc, headquartered in Santa Clara, CA, as well as other network and security solutions including CDSS, ADEM, SD-WAN, FLN, CIE, and PAI as shown in FIG. 4A), such as will be further described below.

FIG. 4B illustrates an example use case for mobile users not being able to connect to a corporate network due to authentication issues. For example, multiple computing components/entities and network connections between these different computing components/entities generally makes it technically challenging for a customer (e.g., a customer Network Operations Center (NOC) and/or IT/helpdesk personnel) to determine a root cause for any application connectivity issues. Specifically, the disclosed techniques for the Application Access Analyzer provide an automated tool for the customer/customer NOC to analyze and detect potential issues with SASE/Prisma Access for a user(s)/group of users to access one or more applications (e.g., SaaS/Private Apps), such as will be further described below with respect to various embodiments.

Referring to FIG. 4B, this example use case illustrates the challenge to manually correlate discrete events, as shown at 420, in which mobile users were unable to connect to a corporate network due to authentication issues. Specifically, the manual analysis and correlation required two weeks of troubleshooting to finally diagnose this issue with a customer's authentication server.

FIG. 4C illustrates an example use case for reducing Mean Time To Detect (MTTD)/Mean Time To Resolve (MTTR) for access to SaaS/Private Apps using AIOPs for Secure Access Service Edge (SASE) in accordance with some embodiments. Specifically, in this example use case, excessive authentication (Auth) timeout failures in all SASE (e.g., Prisma Access (PA)) locations were resolved in minutes (e.g., instead of hours or days) using the disclosed AIOPs for SASE as will be further described below.

Specifically, the disclosed AIOPs for SASE address various technical problems as will now be described. MTTD & MTTR for application (App) access issues are typically in hours, which can increase application downtime and adversely impact productivity and revenue for enterprises. Troubleshooting and debugging generally requires domain knowledge expertise. Further, co-relating and tracking multiple factors to perform root cause analysis (RCA) is often cumbersome and error prone when performed manually.

For example, an enterprise and/or cloud service provider having multiple hosted network services, large network infrastructure, and complex security policy configuration can encounter significant challenges to reduce MTTR of App access issues.

As another example, identifying RCA in an enterprise organization can generally require comprehensive checks of various domains, such as network connectivity, infrastructure reachability, and security policy reasoning.

Referring to FIG. 4C, an excessive Auth failure is detected as shown at 430. At 432, a dynamic baseline automatically detects an anomalous drop in mobile user count, and automated monitoring of the Auth server using cloud probe VMs determines that the Auth server is available and that the network path to the Auth server is available (e.g., up and running without performance degradation or other reachability issues) using the disclosed AIOPs for SASE. At 434, ML correlation is performed using the disclosed AIOPs for SASE to generate a single actionable incident that isolates the cause as being the result of the Auth service not responding that is impacting 1200 mobile users being unable to connect in the US West region, to thereby focus resolution on the Auth server. At 436, the incident is resolved using the disclosed AIOPs for SASE as it is verified that the Auth timeout failures and mobile user count in all SASE PA locations are now in normal range. As such, the disclosed techniques utilizing topological co-relation facilitate improved MTTD/MTTR for access to SaaS/Private Apps using AIOPs for SASE in accordance with some embodiments.

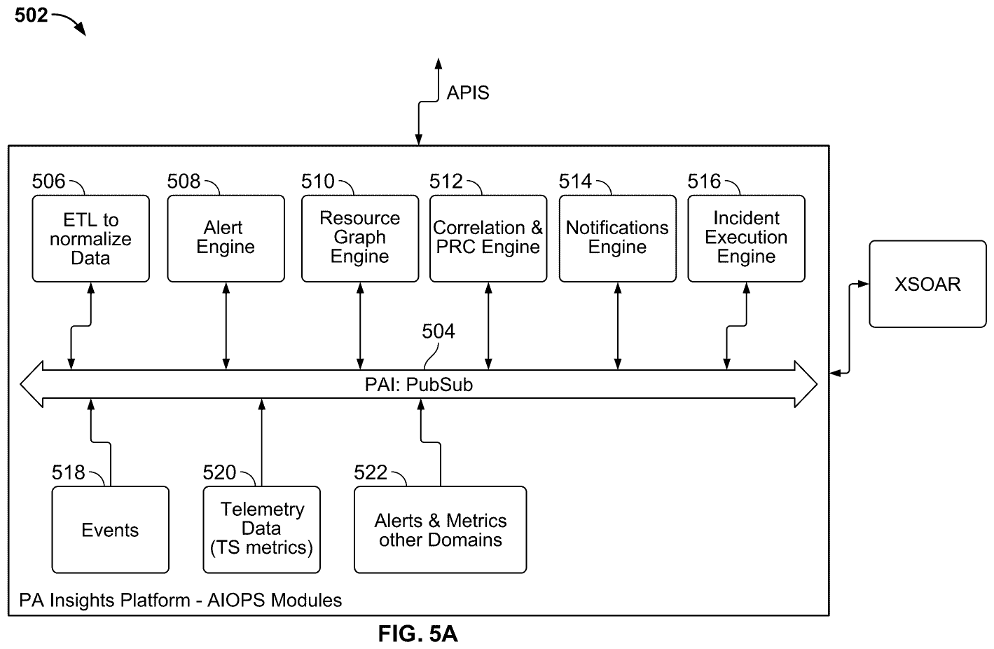

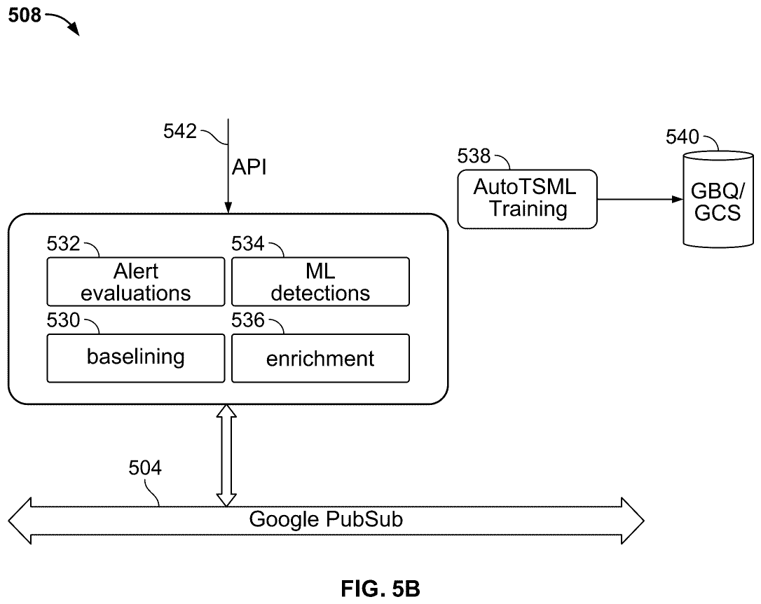

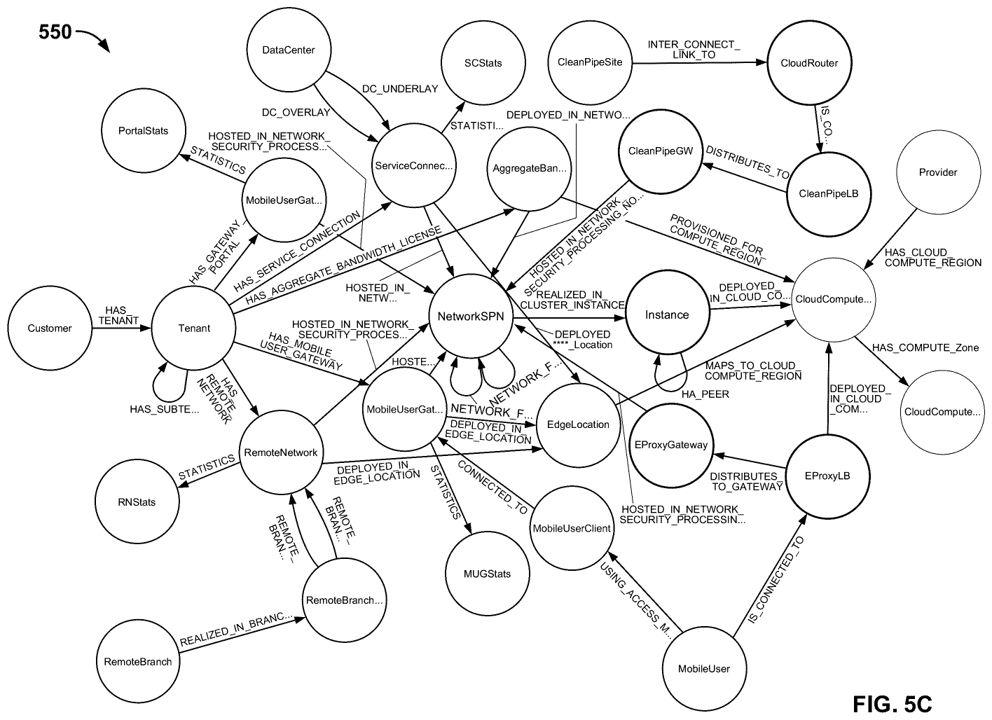

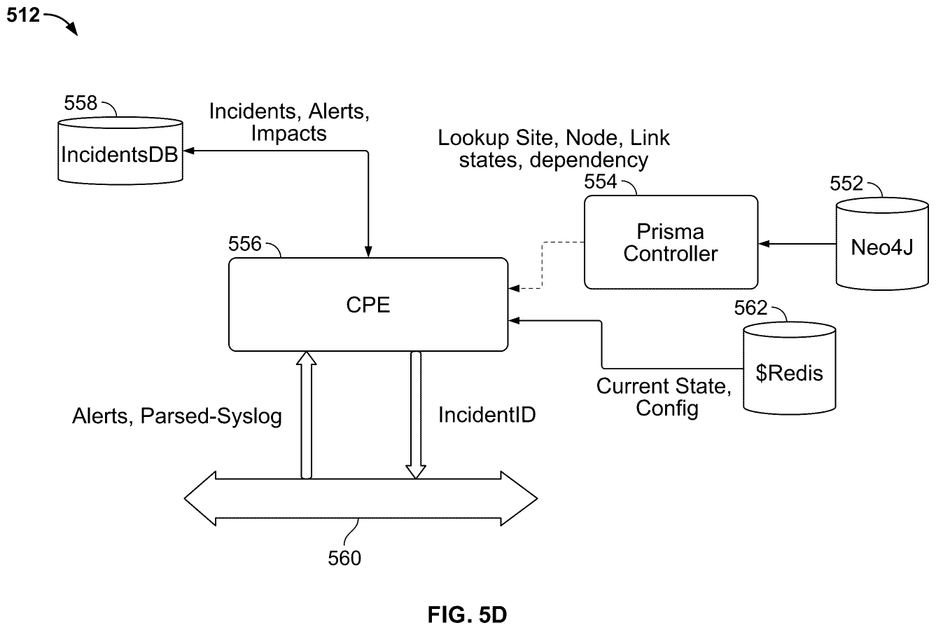

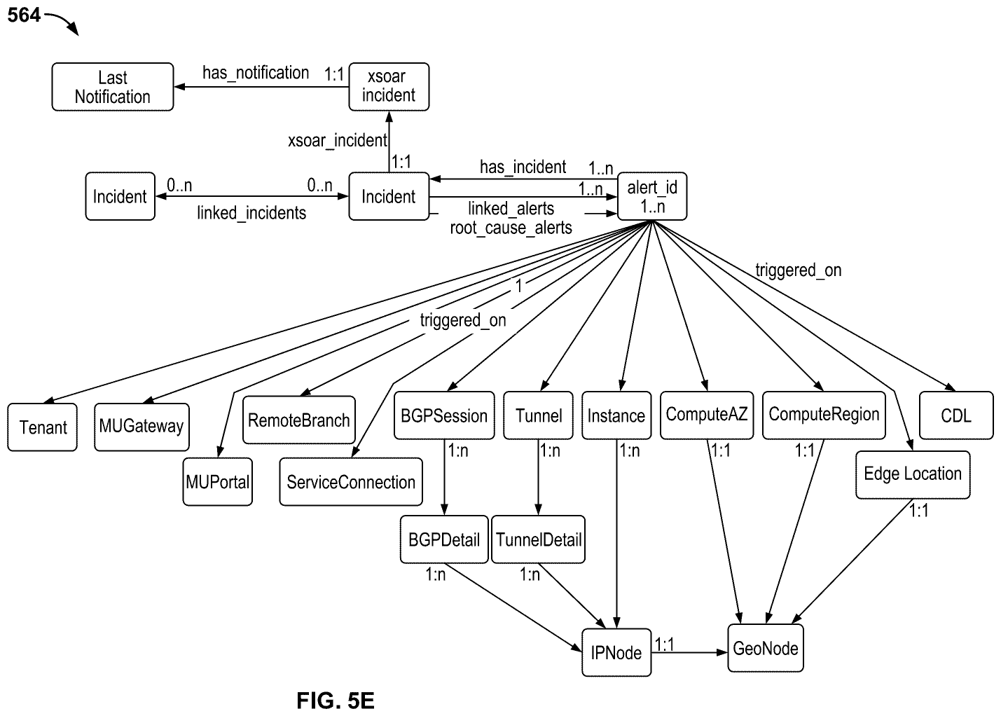

FIG. 5A illustrates an AIOPs for SASE architecture to facilitate topological co-relation in accordance with some embodiments. As shown at 502, a Prisma Access (PA) AIOps platform provides proactive service level management across customers globally and is designed for use by NOC personnel supporting Prisma Access (PA)/SASE customers. Specifically, this diagram shown in FIG. 5A illustrates a high-level architecture of the AIOPs services and their interactions including the data processing pipeline and applications (GKE) deployed as part of the Prisma Access Insights (PAI) platform as will now be further described below.

Prisma AIOPs provide proactive monitoring, alerting, problem isolation, and playbook-driven remediation to provide SLA (MTTK/I, MTTR) as required by customer(s). Prisma AIOPs are built on an Insights platform (e.g., referred to as the Prisma Access Insights (PAI) platform) that provides cross domain NOC capabilities (e.g., including Prisma SD-WAN (CGX), etc.). The PAI platform includes a publish/subscribe communication mechanism 504 as shown in FIG. 5A that facilitates communication between the various components including an Extract Transform Load (ETL) to normalize data 506, an alert engine 508, a resource graph engine 510, a Correlations and PRC Engine (CPE) 512, a notifications engine 514, and an Incident Execution Engine 516 (e.g., the IEE component can provide the following functionalities: (1) policy management for incidents, such as suppression policies, role management, etc.; (2) Role-Based Access Control (RBAC) for incident API(s); and (3) API(s) for dashboards, single customer and aggregate across customers; and the IEE component can also provide impact analysis, such as from CDL traffic logs to understand between drops or number of users impacted, and when an incident is created based on a customer impacted object (alerts) in the incident, then the IEE can fetch the corresponding impact based on keys from the impact structure), and data sources including events 518, telemetry data 520 (e.g., telemetry data can be collected from various sources, such as firewalls including PANOS syslogs for system log data, operation data including cloud infrastructure monitoring data such as for AWS, GCP health data, application data, and Cortex Data Lake (CDL) data; cross-domain telemetry data can also be made available for cross-correlation), and alerts & metrics for other domains 522.

Specifically, FIG. 5A illustrates a high-level architecture of the AIOPs services and their interactions. Engines/services above are part of the data processing pipeline and applications (GKE) deployed as part of the PAI platform.

FIG. 5B illustrates an alert engine in accordance with some embodiments. As shown at 508, the alert engine includes sub-components for alert baselining 530, alert evaluations 532, ML detections 534, and enrichment of the alerts information 536. The ML detections are trained using the AutoTSML training component 538 that is in communication with a data store shown as Google Big Query (GBQ)/Google Cloud Store (GCS) 540.

In an example implementation, alerts can be reactive and predictive. Examples of reactive alerts include CPU thresholds going beyond some anomalies. Predictive alerts are alerts on metrics that provide a future time or event when such a behavior could occur. Examples of predictive alerts include capacity planning alerts on link utilization that provide information about when a link could saturate. Also, alerts can be threshold-based (e.g., configurable/programmable thresholds), simple baseline (e.g., average) and compared with SD or ML time (AutoTSML) series-based. As also shown in FIG. 5B, the alert engine includes ML-based detections, which can be trained using its own infrastructure for training, model validation, deployment, etc.

For example, the disclosed alert engine service can generate alerts based on any of the telemetry data that is available in the system via telemetry data sources. The alert engine also includes an API(s) as shown at 542 that can be used to create via predefined models (e.g., templates like SD or ML, etc.). One such example is using Influx TICK language or ProMQL or google MQL so as to pick fields and evaluation expressions. The following three templates are example minimum requirements: (1) general threshold-based; (2) SMA/EMA and SD-based; and (3) MAD. All of these example templates are stateful (e.g., they track alert states and state transitions). Also, such alerts can be persisted and propagated to other services via the PubSub for consumption as shown at 504 of FIG. 5B.

Below is an example implementation of an alerting output schema.

```
{
    tenant: “”,
    source: “”,
    severity: “Info|Low|Medium|High|Critical”,
    Keys: { },
    Data: { },
    alert_code: “tunnel_status|process_cpu|..”,
    analysis_type: “reactive|predictive”,
    event_time:,
    alert_time:,
    message: “human readable data”,
    tags: “” // tags can be other relevant, enriched data sets
}
```

FIG. 5C illustrates an example relationship between various entities that is automatically generated and used for correlation and PRC in accordance with some embodiments. Specifically, the example relationship is a graph as shown at 550 that can be generated using the resource graph engine as shown at 510 in FIG. 5A.

In an example implementation, resource graph engine 550 is implemented as a resource builder graph (RBG) that provides a relationship model of the full End-to-End (E2E) computing environment from any given user to each application (e.g., SaaS/Private App). The resource graph is a hierarchical (e.g., a node in the graph can be a subgraph with relationships), generic knowledge map that is generated to be used for correlation/causation analysis, such as for performing topological co-relation techniques as described herein. At the highest level of the resource graph, a cross-domain network model is used that connects users to an application(s) via various domains, such as SASE/Prisma Access, SASE/Prisma SD-WAN, etc. Within each of these domains, there is a network model that has various nodes based on the connectivity, such as a VPN/GP, Remote Network (RN), proxy, SD-WAN (e.g., SD-WAN fabric), etc. In this example implementation, the cross-domain network model includes control, management, and data plane relationships between entities. Within each of these domains, each node or link includes a subgraph that describes the relationship across components, processes, etc. An example of a node subgraph is the relationship between IKE and IPSec related processes within a Virtual Machine (VM) (e.g., IKE and IPSec pan task processes in a Palo Alto Networks (PAN) VM implementation). Also, when connecting multiple domains, the key identifiers (e.g., App, Tenant, User ID, etc.) can be normalized. For example, a network/system administrator (admin) with domain knowledge can specify the relationship via a meta language, and the RGB uses the alerts/events with tags to construct the graph as described above.

FIG. 5D illustrates a Correlation and Prisma Controller Engine (CPE) in accordance with some embodiments. As shown at 512, the CPE includes sub-components for a data store (e.g., Neo4J or another commercially available or open source graph data store can similarly be used for this sub-component) 552, a Prisma Controller 554 (e.g., to look up Site, Node, Link states, dependency information), a Correlation and Causation sub-component 556, an Incidents data store/database (DB) sub-component 558 (e.g., for storing incidents, alerts, impact information), an Alerts, Event communication pipeline 560 (e.g., for receiving Incident ID information from CPE 556 and sending alerts, parsed SYSLOG information to CPE 556), and a Redis 562 (e.g., an open source, in-memory data structure store used as a database, cache, message broker, and streaming engine, which in this example implementation can be used for providing current state, configuration information to CPE 556 as shown in FIG. 5D).

In this example implementation, Correlation and PRC Engine (CPE) (e.g., shown as CPE 512 in FIG. 5A and as CPE 556 in 5D) facilitates correlation and deduplication. Correlation and deduplication can be used in various situations. As an example, consider a scenario of a VM (e.g., a Remote Network associated with a Remote Network-Service Provider Network (RN-SPN)) going down, and then a burst of events of a tunnel being down are received from all of the other nodes that are connected to this VM. Whether such is a result of planned downtime or an unplanned outage, it is generally desirable to aggregate these related events/alerts into a single incident to facilitate a more effective and efficient identification of the root cause and remediation/response (as needed). In the above example scenario, the probable root cause is the VM down event. As such, correlation as used herein generally refers to a process of aggregating and/or clustering events/alerts based on temporal or relational boundaries to facilitate the disclosed topological co-relation techniques. Deduplication as used herein generally refers to a process of identifying duplicate events and then combining such duplicate events into alerts (e.g., a single/consolidated alert). Deduplication thereby reduces the number of alerts in the system (e.g., reducing noise for network/system/IT admins/users).

Generally, there are two high-level approaches for performing the above-described correlation and deduplication processes: (1) rule-based; and (2) AI/ML-based. Rule-based is an approach in which a system/domain expert is typically defining the root cause by an IF This Then That (IFTTT) form of language either in code or using a meta language. Rule-based engines can also use a relationship graph to walk and associate incoming alerts to part of the DAG analysis. This rule-based approach may work initially or for a subset of cases, but over time such a rule-based approach can become obsolete as new relationships or services are added to the infrastructure.

In contrast, ML/AI-based techniques use the relationship built using the above-described RGB as the input and the time range at which the events/alerts occurred. Clustering techniques for time or centrality-based algorithms based on proximity yield efficient and effective results. Example output of the above-described CPE (e.g., shown as CPE 512 in FIG. 5A) is an incident with a collection of alerts/events and indication of PRC, which is made available to other services (e.g., other interested services, which can subscribe to such alerts/events).

Typically, correlation looks at temporal and relationship as dependency. For example, a tunnel going over an interface and an interface goes down etc. Most systems also look at dependency and topological relationships as static distances. In contrast, in the disclosed topological co-relation techniques, the disclosed model views topology as a dynamic state, derived via hop-by-hop metrics and events that can happen on any of the hops. Such events are then correlated to isolate the symptoms from the problem and enable rapid root cause analysis as further described herein with respect to various embodiments.

FIG. 5E illustrates an example data model for the AIOPs platform in accordance with some embodiments. Specifically, the example data model for the AIOPs platform is shown at 564 in FIG. 5E.

Below is an example implementation of a correlation graph schema.

```
bgp_connection:
      trigger_on:
            - BGPSession
            - primary
            - Tunnel
            - Instance
                  - connected
            - CloudComputeRegion
      suppress_if:
            - cloud_instance
            - tunnel_connection
      alert_src: alerts.pa.bgp
      alert_code: bgpconnection_alert
tunnel_connection:
      suppress_if:
            - cloud_instance
      correlate_with:
            - tunnel_process_cpu:
                  weight: 50.0
            - tunnel_process_mem:
                  weight: 50.0
            - tunnel_drops:
                  weight: 50.0
      alert_src: alerts.pa.tunnel
      alert_code: tunnel_alert
tunnel_process_cpu:
      suppress_if:
            - cloud_instance
      alerts_src: alerts.pa.process
      alerts_check_type: proc_cpu
cloud_instance:
      suppress_if:
            - cloud_region
            - cloud_az
      alert_src: alerts.pa.instance
      alert_code: instance_state
cloud_az:
      impact_type: “global”
      weight_ext: 100.0
      suppress_if:
            - cloud_region
      alert_src: alerts.pa.cloud
      alert_code: az_status
cloud_egion:
      impact_type: “global”
      alert_src: alerts.pa.cloud
alert_code: region_status
weight_ext: 100.0
correlation: “1.0”
```

Below is an example implementation of correlation data structures.

```
enum code_enum {
      tunnel_status,
      tunnel_rtt,
}
type alert_node {
      alert_id: UUID!
      alert_code: code_enum!
      alert_source: event|alert|manual!
      severity: string
      state: raised|cleared
      create_time: DateTime
      raised_time: DateTime
      cleared_time: DateTime
      update_time: DateTime
      first_event_time: DateTime
      last_event_time: DateTime
      customer_obj: Bool
      // one_to_many
      has_incidents: [incident_node]
      triggered_on_rn:
      triggered_on_mu:
      triggered_on_sc:
}
type incident_node {
      incident_id: UUID!
      incident_code: String!
      state: holding|created|cleared
      severity: string
      create_time: DateTime
      raised_time: DateTime
      cleared_time: DateTime
      update_time: DateTime
      has_alerts: [alert_node] @relation (name: “IN_INCIDENT”,
      direction: IN) //many to many
      root_cause_alerts: [alert_node]
      linked_incident_parent: [incident_node]
      linked_incident_child: [incident_node]
      linked_incident_peer: [incident_node]
      has_xsoar_incident: [ xsoar_incident ]
}
type xsoar_incident {
      xsoar_instance_id: String!
      xincident_id: String!
      oper_status: String!
      has_notification: [notification]
      on_incident: [incident_node]
}
type notification {
      time: DateTime
      status: Int! (Detected (1) Investigating (2) RootCauseFound
      (3) FixApplied (4) Monitoring (5) Resolved)
      description: String
      follow_incident: [ xsoar_incident ]
}
type CloudProvider {
      name: String!
}
type CloudComputeRegion {
      cloud_provider: String!
      name: String!
      created_time: DateTime
      on_geo: [GeoCoordinates]
}
type CloudComputeZone {
      cloud_provider: String!
      cloud_region: String!
      name: String!
      created_time: DateTime
      on_geo: [GeoCoordinates]
}
type CDL {
      tenant_id: String!
      sub_tenant_id: String!
      cdl_tenant_id: String!
      cdl_fqdn: String
}
type EdgeLocation {
      cloud_compute_region: String!
      cloud_provider: String!
      name: String!
      on_geo: [GeoCoordinates]
}
type Tenant {
      tenant_id: String!
      sub_tenant_id: String!
      name: String
}
type Instance {
      tenant_id: String!
      sub_tenant_id: String!
      instance_id: String!
      topology_type: Int
      cloud_instance_id: String!
}
type RemoteBranch {
      tenant_id: String!
      sub_tenant_id: String!
      oid: String!
      name: String
}
type ServiceConnection {
      tenant_id: String!
      sub_tenant_id: String!
      oid: String!
      name: String
}
type MUGateway {
      tenant_id: String!
      sub_tenant_id: String!
      oid: String!
      name: String
}
type MUPortal {
      tenant_id: String!
      sub_tenant_id: String!
      oid: String!
      name: String
}
type Tunnel {
      site_name: String
      tunnel_name: String!
      sub_tenant_id: String!
      tenant_id: String!
      tunnel_type: String!
      tunnel_detail: [ TunnelSession ]// one to many
}
type TunnelSession {
      create_time: DateTime
      update_time: DateTime
      is_active: bool
      source_ip: String
      source_ip_prop: [IPNode]
      dest_ip: String
      dest_ip_prop: [IPNode]
}
type BgpSession {
      name: String!
      pa_tenant_id: String
      session_type: String!
      site_name: String
      sub_tenant_id: String!
      tenant_id: String!
      bgp_detail: [ BGPDetail ]
}
type BGPDetail {
      create_time: DateTime
      update_time: DateTime
      is_active: bool
      source_ip: String
      source_ip_prop: [IPNode]
      dest_ip: String
      dest_ip_prop: [IPNode]
      localAS: String
      RemoteAS: String
}
type IPNode {
      ip: String!
      isp: String
      geo: [ GeoCoordinates ]
}
type GeoCoordinates {
      latitude: Float
      longitude: Float
}
```

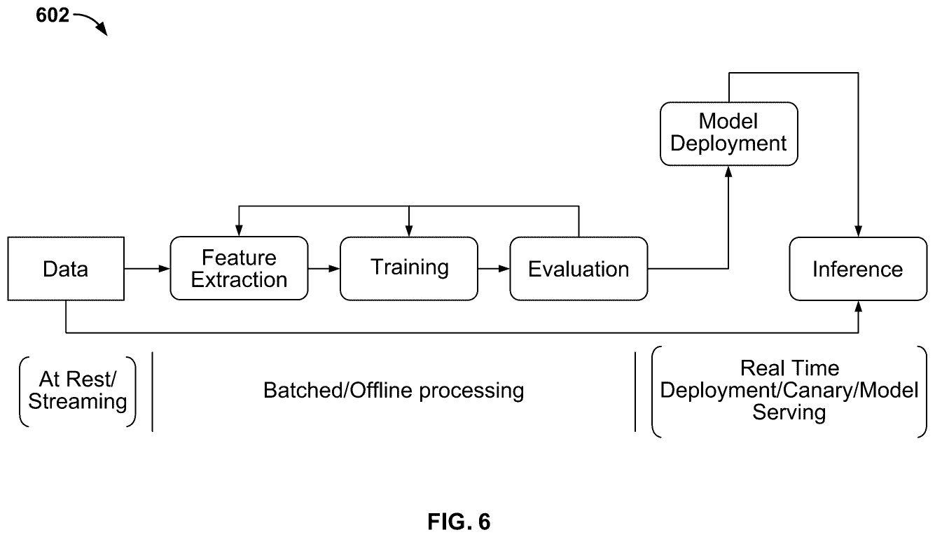

FIG. 6 illustrates an ML pipelines architecture for an AIOPs for SASE solution to facilitate topological co-relation in accordance with some embodiments. In an example implementation, the disclosed AIOPs for SASE architecture that performs topological co-relation utilizes AI/ML techniques for performing various operations including the following: (1) anomaly detection (e.g., detecting tunnel degradation behavior, such as Round-Trip Time (RTT); and detecting packet drop errors); (2) forecasting (e.g., forecasting for memory leakage; file descriptor usage; and disk usage); and (3) causality modeling (e.g., for automated and enhanced RCA for App access issues in a SASE computing environment and/or other networking/performance related issues, such as described herein with respect to various embodiments).

Referring to FIG. 6, an example ML pipelines architecture for an AIOPs for SASE solution to facilitate topological co-relation is shown at 602. In this example implementation, the ML pipelines architecture can utilize an open source and/or managed service model for executing the ML pipelines (e.g., a Google managed AI/ML pipeline infrastructure that executes KFlow underneath for both training and serving purposes). Various AI/ML algorithm libraries can be used for the deployment of the models and inference servers. An example AI/ML library includes a composable version of the AutoTSML library for production deployment Anomaly detection for Prisma AIOps for providing near real-time inference.

Generally, as similarly discussed above, network admins typically either over provision the network due to a lack of data driven approaches or embark on capacity planning exercises only after they have reached or exceeded current configured capacity limits, which results in a poor application experience for end users. Accordingly, the disclosed AIOPs solution includes providing forecasting information in accordance with some embodiments.

### Example Uses Cases for Forecasting

Various use cases for forecasting will now be described.

As a first example use case, historical bandwidth utilization data can be used to train machine learning models to be able to forecast/predict capacity usage.

As a second example use case, forecasting information/data enables network admins to more effectively and efficiently perform data driven capacity planning (e.g., forecasting expected bandwidth needs for a SASE customer in N months, based on user input including a number of users and a number of applications, how much bandwidth would be required for initial deployment of a SASE customer, etc.). For example, forecasting can be applied to predict that a given Service Connection (SC) will exceed capacity in N days (e.g., 30 days), and as a result, users would potentially experience a degradation in private/SaaS App experience if capacity is not sufficiently increased in N days.

As a third example use case, forecasting can be used for automatically alerting a network admin when the forecasted bandwidth is going to exceed a user defined threshold.

As a fourth example use case, forecasting can be used for a SASE provider to proactively reach out to their customers with forecasting data to proactively increase bandwidth based on forecasting network capacity for such customers (e.g., if we add N number of more users to a branch site, what will be the bandwidth usage or requirements; if we enable one or more applications, such as Microsoft Teams or Zoom, what would be the forecasted additional bandwidth that would be required).

As a fifth example use case, forecasting can be used for providing remediation playbooks to assist in capacity planning (e.g., for SASE customers).

As a sixth example use case, forecasting can be applied for forecasting incidents (e.g., incidents forecasting in a given SASE deployment). For example, forecasting/predictive analytics can be applied to predict excessive Auth timeout failures due to an issue with a customer Auth server.

As a seventh example use case, forecasting/predictive assessment can be used for providing a what-if analysis to determine that a user's access to a private/SaaS App is a result of recent configuration changes (e.g., the user's access to Microsoft Outlook is impacted by recent Active Directory (AD) group changes). As another example, a customer IT administrator can use the AIOPs platform natural language (NL) interface to submit an NL query to perform multi-domain analysis for a new private/SaaS App rollout across all user locations before a given user complains about access issues.

As an eighth example use case, forecasting/predicting assessment can be used for enhanced security analysis (e.g., using formal modeling of security policies for an enterprise). For example, a security administrator can verify whether a new policy allows an engineering user group to access a private/SaaS App (e.g., Salesforce), and whether the security policy analyzer shows an overlapping/shadow rule for that user group's access to that App. As another example, a network security (NetSec) administrator can perform a pre-change sandbox analysis to determine whether adding a new policy (e.g., to allow HVAC systems access to a patch server) would result in a compliance violation.

### Use Case Scenarios for Topological Co-Relation

Various use cases for providing topological co-relation and related disclosed new and improved techniques will now be described.

As a first example use case scenario, the disclosed topological co-relation techniques can be applied to facilitate effectively and efficiently performing a root cause and/or other analysis for access for a user(s) and/or a group of users to a SaaS application from Mobile user Gateways.

As a second example use case scenario, the disclosed topological co-relation techniques can be applied to effectively and efficiently facilitate performing a root cause and/or other analysis for access for a user(s) and/or a group of users to a Private Application hosted at on-premises data centers or on a remote branch office.

As a third example use case scenario, the disclosed topological co-relation techniques can be applied to facilitate effectively and efficiently performing a root cause and/or other analysis for access for a user(s) and/or a group of users to remote site connectivity to a Remote branch or a Data Center.

As a fourth example use case scenario, the disclosed topological co-relation techniques can be applied to facilitate effectively and efficiently performing multi-domain contextual troubleshooting analysis with actionable results. For example, the multi-domain contextual troubleshooting analysis can include end points, SASE/Prisma Access, Authentication, DNS, Layer 3 Forwarding, Security Policy, Threat Prevention, Private/SaaS Application access, and/or various other domains that can be automatically analyzed using the disclosed techniques to facilitate actionable verdicts (e.g., yes/no verdicts; correlation and root cause analysis to identify a problem and remediation action(s); and/or per domain deep observability to facilitate a more rapid remediation).

As a fifth example use case scenario, the disclosed topological co-relation techniques can be applied to detect various anomalies, including a brownout due to a DDoS event/attack; a spike in volume of traffic on a tunnel (BW increase), due to the specific App or specific set of endpoints (e.g., anomalously behaving laptop); and performance impact for other users—currently customers don't have unified visibility into security attacks and or their impact on the network behavior. One such example is a DDoS attack on the DNS server. It manifests as saturation of network capacity and network operators may plan on augmenting capacity as a solution. With Incident framework in AIOps, firstly we build a baseline (based on time series trends with seasonality) of the metrics such as DNS request/response rates and bandwidth usage on the secure connectivity between Prisma access and customer's private data center to determine anomalous behaviors. Then our correlation logic correlates the anomalous DNS traffic pattern with an increase in bandwidth consumption. We generate an incident with the above context which enables the NetSec admin to root cause the saturation of the network resources due to a DNS DDoS attack. More so we can also provide further context of the source addresses from which these DNS requests are arising so that the security admin could add a policy to block the traffic to enable faster remediation and return to normal operating conditions.

As a sixth example use case scenario, the disclosed topological co-relation techniques can be applied to detect various anomalies, including auth timeout failures, DNS failures, SaaS/Private App not reachable, SC BGP down, SC tunnel down, etc. For example, alerts can generally be generated to alert a customer's IT on the health and performance issues of individual objects such as a tunnel, auth server, DNS, etc. However, this can lead to burning multiple resources to manually determine that these are related events where one is the problem, and the others are merely symptoms of the problem/root cause. For example, the Data Center tunnel can have performance or health issues that can lead to BGP flaps, packet drops, poor private application experience, DNS failures, and/or auth failures. As such, the disclosed topological co-relation techniques can be applied to correlate these discrete events across discrete data sources and deliver a single actionable incident that is the problem/root cause (e.g., the data center connectivity degradation causing the following symptoms, such as BGP flaps, packet drops, poor app experience, DNS failing, auth failing, etc.), which thereby reduces manual correlation and improves customer IT efficiency in troubleshooting and proactive remediation of the problem/root cause.

As a seventh example use case scenario, the disclosed topological co-relation techniques can be applied to detect various anomalies, including a CIE agent disconnect, user group count deviation from a baseline, and a rule-hit deviation. For example, a potentially malicious masquerading user can be detected when the same user/user-id is logged into the corporate network from two geographically distant locations within a time interval that is not feasible (e.g., time travel violation as the user is logging into two distinct locations within a period of time that such physical travel by that user would not be feasible). Customers can specify various security policies and authentication policies based on user groups. The cloud security service can then learn about these user groups periodically from the LDAP/AAA/AD servers. If there is a disconnect between the security service and the LDAP/AAA/AD server, then this results in outdated user-group information. This can cause denial of access. As part of this proactive anomaly detection, the disclosed techniques can include monitoring and generating a baseline for user-groups, users per group, security rule hits for access to applications, etc. Such baseline deviations can then be correlated with either loss of connectivity to the Active Directory (AD) or a drop in group counts. Further, such correlated anomalies can be proactively alerted to customer IT admins to rectify the root cause before multiple users complain about such potential application access issues.

As an eighth example use case scenario, the disclosed topological co-relation techniques can be applied to detect various anomalies, including co-relating incidents to the impact on the basis of users and application. For example, in existing IT support systems, IT admins can generally attempt to determine a potential impact in its organization by looking at a total number of user related complaints/tickets that are raised around the same period of time. The existing IT support systems are mostly reactive in assessing the actual impact to the organization. The disclosed techniques can include an incident framework with the AIOPs solution that provides context about the incident by augmenting the users, bandwidth, or application access or a combination thereof when incidents are created, and the scope of impact is updated in near real-time. Moreover, such topological co-relation information related to network access/metrics, etc. can be used by network operators and IT admins to facilitate an efficient and effective prioritization of the most impactful incidents and also enable the helpdesk to more rapidly resolve and close user trouble tickets.

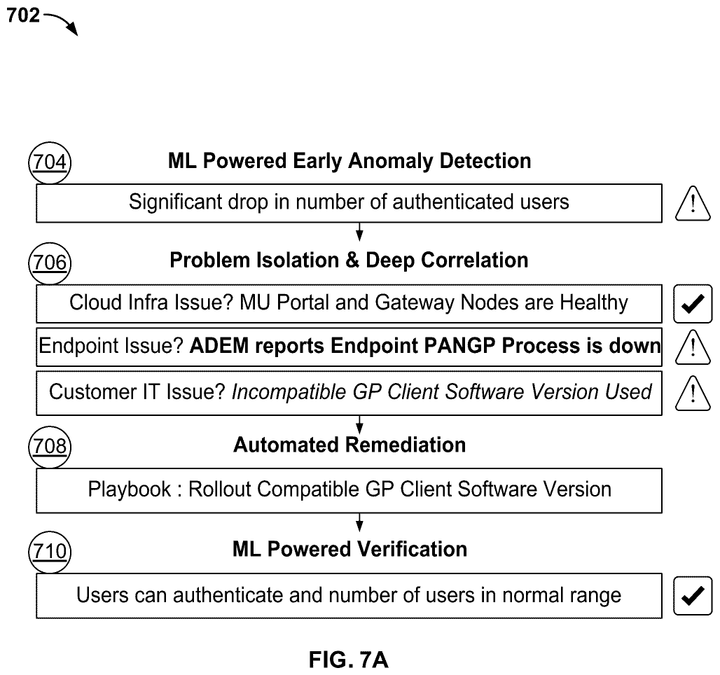

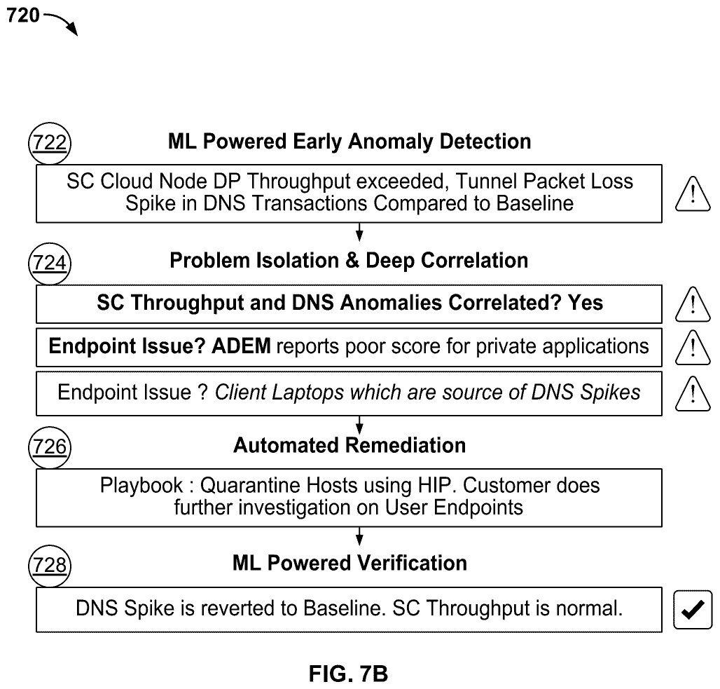

FIG. 7A illustrates an example use case for a significant drop in authenticated users detection in accordance with some embodiments. FIG. 7A illustrates an example use case processing as shown at 702. At 704, a significant drop in a number of authenticated users is detected using the disclosed ML powered early anomaly detection techniques. At 706, problem isolation and deep correlation are performed using the disclosed topological co-relation techniques. Specifically, whether it is associated with a cloud infrastructure issue is determined by verifying that the MU portal and gateway nodes are healthy, and whether it is associated with an endpoint issue is determined by verifying that an endpoint VPN related process (e.g., GP VPN endpoint agent process) is down, which is determined to be a result of an incompatible GP client software version being used as shown at 706. At 708, automated remediation is performed using a computational playbook that facilitates an automated rollout of compatible GP client software versions to the endpoints. At 710, ML powered verification is performed. Specifically, whether users can authenticate and that a number of users is in an expected/normal range (e.g., based on a baseline analysis of a number of users) is determined.

FIG. 7B illustrates an example use case for a service connection cloud node anomaly detection in accordance with some embodiments. FIG. 7B illustrates an example use case processing as shown at 720. At 722, the disclosed ML powered early anomaly detection automatically detects a service connection cloud node anomaly. Specifically, the anomaly detection is associated with a service connection (SC) cloud node DP throughput being exceeded, and a tunnel packet loss spike in DNS transactions (e.g., relative to a previously computed baseline). At 724, problem isolation and deep correlation is performed using the disclosed topological co-relation techniques. Specifically, that the SC throughput and DNS anomalies are correlated is determined, and ADEM reports indicate a low score for private applications to indicate potential endpoint related issues, as shown at 724. At 726, automated remediation is performed using a computational playbook that facilitates an automated remediation that quarantines hosts using Host Information Profiles (HIP) to allow a customer to perform further investigation into the quarantined user endpoints. At 728, ML powered verification is performed to verify that the DNS spike is reverted to a baseline/normal range and that the associated SC throughput is also reverted to a baseline/normal range.

Various process embodiments for topological co-relation techniques will now be further described below.

### Example Processes for Performing Topological Co-Relation Techniques

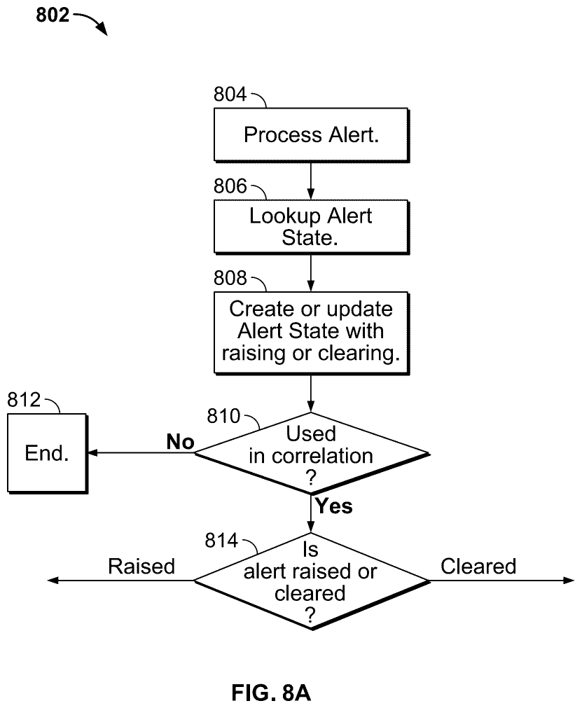

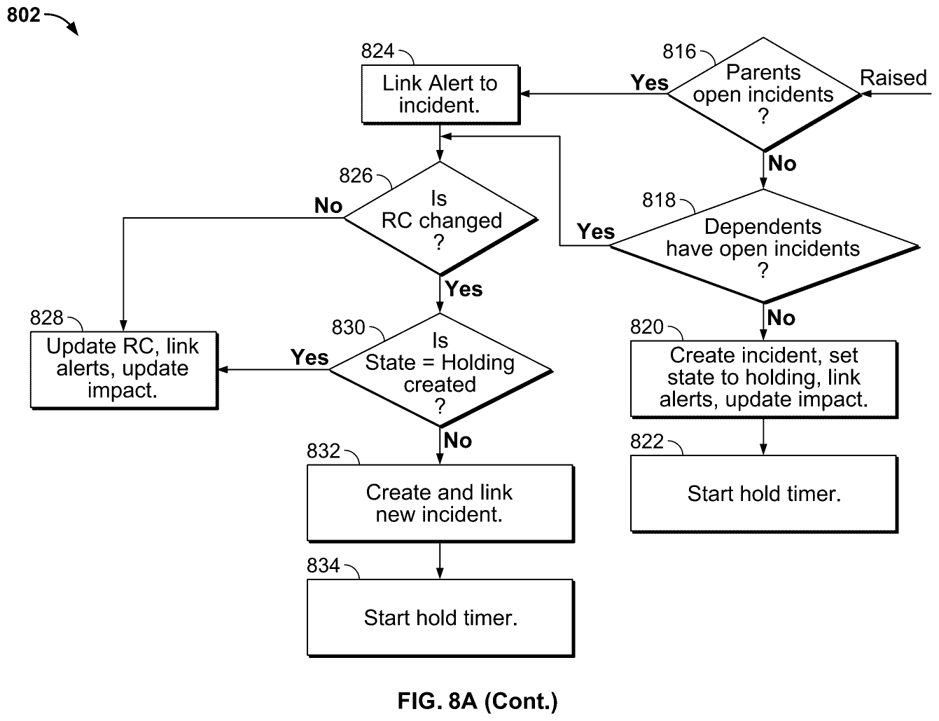

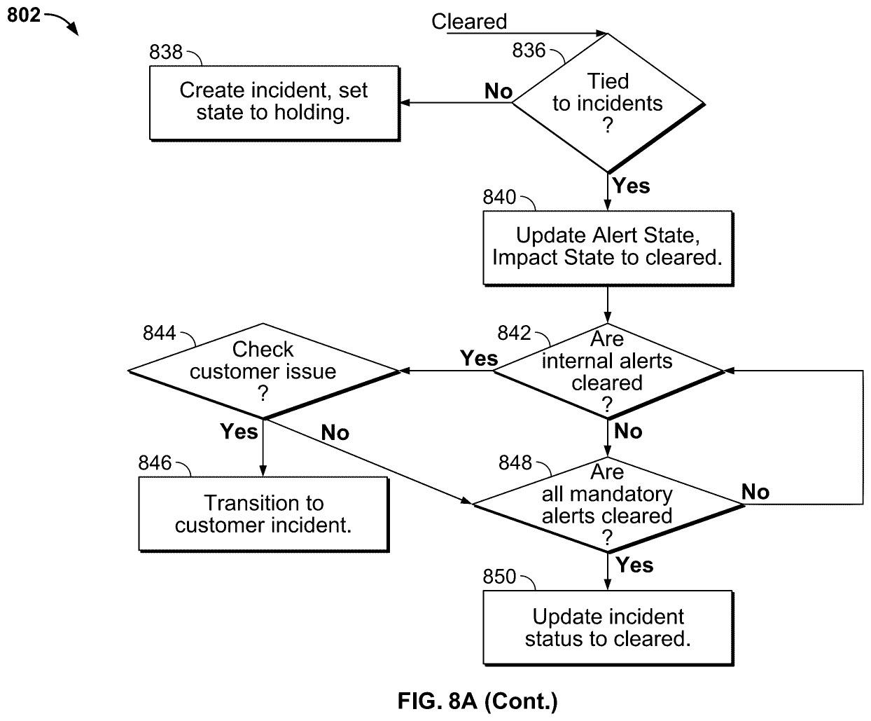

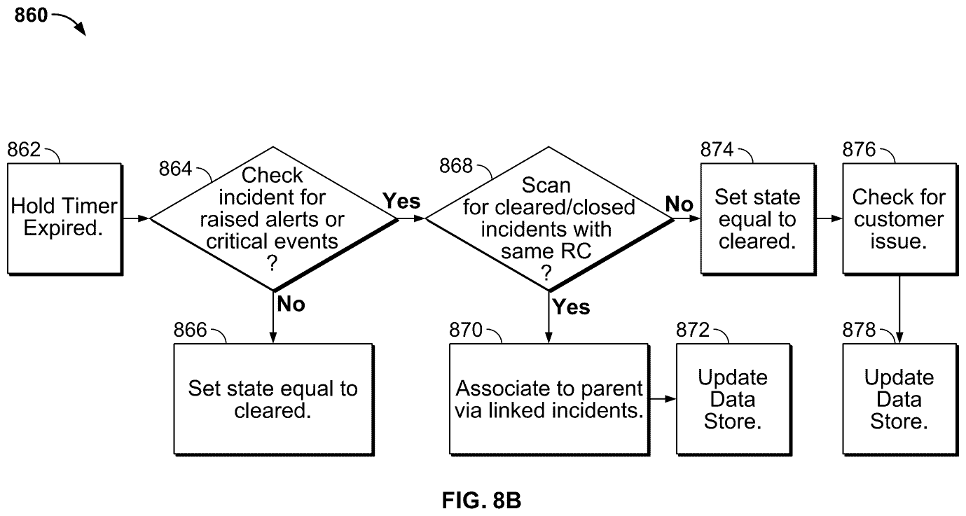

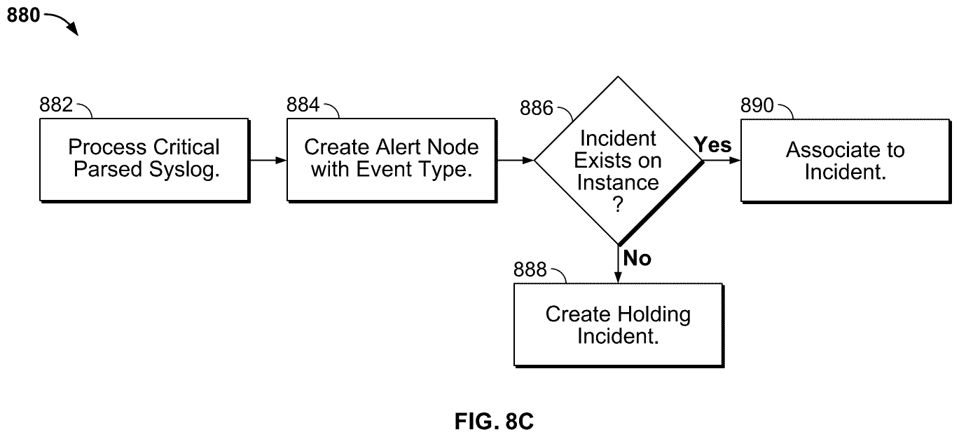

FIGS. 8A-8C illustrate processes for performing correlation for an AIOPs SASE solution to facilitate topological co-relation techniques in accordance with some embodiments. In some embodiments, processes 802, 860, and 880 as shown in FIGS. 8A-8C are performed using CPE 512 and techniques as similarly described above including the embodiments described above with respect to FIGS. 4A-7B.

Referring to FIG. 8A (e.g., as provided in FIGS. 8A-1, 8A-2, and 8A-3), a process 802 is illustrated for aggregating alerts and/or critical events as incidents. At 804, an alert is processed. At 806, a lookup of the alert state is performed. At 808, creating or updating the alert state with raising or clearing is performed. At 810, whether the alert is used in correlation is determined. If not, then processing terminates as shown at 812. Otherwise, processing proceeds to 814 and whether the alert is raised or cleared is determined. If the alert is raised, then processing proceeds to 816 and whether the parents have open incidents is determined. If so, then processing proceeds to 824 and a link from the alert to the incident is generated. If not, then processing proceeds to 818 and whether the dependents have open incidents is determined. If not, then processing proceeds to 820 and the following is performed: create incident, set state to holding, link alerts, and update the impact. At 822, the hold timer is started. If the dependents were determined to have open incidents, then processing proceeds to 826 and whether there is a change in the RC is determined. If not, then processing proceeds to 828 and the following is performed: update the RC, link alerts, and update the impact. If so, then the processing proceeds to 830 and whether the state is set to holding is created is determined. If so, then processing proceeds back to 828 and the following is performed: update the RC, link alerts, and update the impact. If not, then processing proceeds to 832 and the following is performed: create and link new incident. At 834, the hold timer is started. At 836, whether the cleared alert is tied to incidents is determined. If not, then the following is performed: create incident and set state to holding. Otherwise, processing proceeds to 840 and the following is performed: update the alert state and the impact state to cleared. At 842, whether internal alerts are cleared is determined. If so, processing proceeds to 844 and a check for a customer issue is performed. If it is associated with a customer issue, then processing concludes as is associated with a customer incident as shown at 846. Otherwise, processing proceeds to 848 and whether all mandatory alerts are cleared is determined. If so, then the incident status is updated to cleared as shown at 850 and processing concludes.

Referring to FIG. 8B, a process 860 is illustrated for aggregating alerts and/or critical events as incidents. At 862, the hold timer has expired. At 864, whether an incident exists for raised alerts or critical events is checked. At 866, if not, then the state is set equal to cleared. Otherwise, a scan is performed to check for cleared/closed incidents with the same Root Cause (RC) as shown at 868. If yes, then the raised alerts or critical events are associated to a parent via linked incidents as shown at 870, and the data store (e.g., incident data store, such as the Incidents DB as shown at 558 of FIG. 5D) is updated as shown at 872. Otherwise, processing proceeds to 874, and the state is set equal to cleared as shown at 874. At 876, a check for a customer issue is performed. At 878, the data store (e.g., incident data store, such as the Incidents DB as shown at 558 of FIG. 5D) is updated.

Referring to FIG. 8C, a process 880 is illustrated for processing alerts to associate with an incident. At 882, processing of critical parsed Syslog information is performed. At 884, an alert node with an event type is created. At 886, whether an incident exists on the instance is determined. If not, then a holding incident is created as shown at 888. Otherwise, an incident exists on the instance, and the alert is associated with the incident as shown at 890.

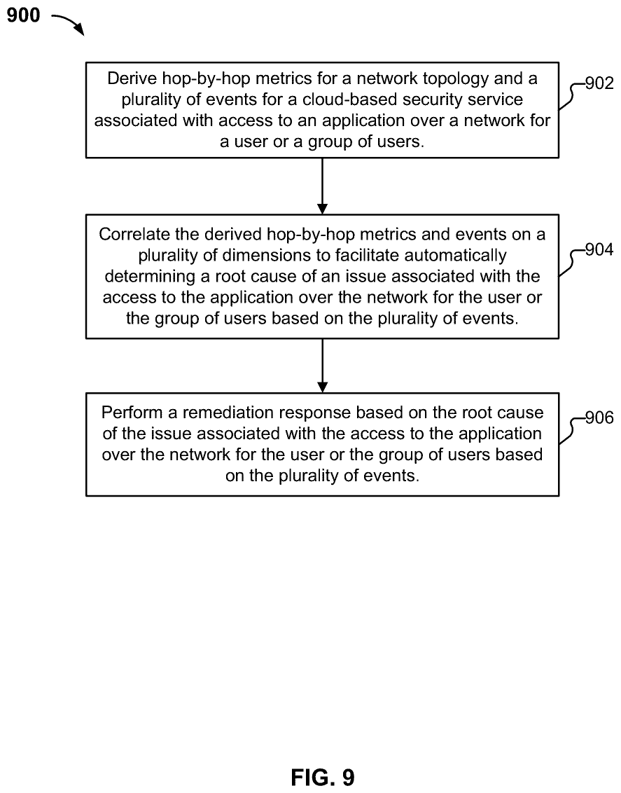

FIG. 9 is a flow diagram of a process for performing topological co-relation techniques in accordance with some embodiments. In some embodiments, a process 900 as shown in FIG. 9 is performed by the disclosed techniques as similarly described above including the embodiments described above with respect to FIGS. 4A-7B.

At 902, deriving hop-by-hop metrics for a network topology and a plurality of events for a cloud-based security service associated with access to an application over a network for a user or a group of users is performed. For example, the network topology can be monitored dynamically (e.g., dynamic hop-by-hop is performed in which the network topology is viewed as a dynamic state, to facilitate deriving hop-by-hop metrics and events than can be associated with and/or occur on any of the hops, so that such events can be effectively and efficiently correlated to isolate the symptoms from the problem and enable rapid root cause analysis), such as similarly described above with respect to FIGS. 4A-7B.

At 904, correlating the derived hop-by-hop metrics and events on a plurality of dimensions is performed to facilitate automatically determining a root cause of an issue associated with the access to the application over the network for a user or the group of users based on the plurality of events, such as similarly described above with respect to FIGS. 4A-7B.

At 906, a remediation response is performed based on the root cause of the issue associated with the access to the application over the network for the user or the group of users based on the plurality of events, such as similarly described above with respect to FIGS. 4A-7B.

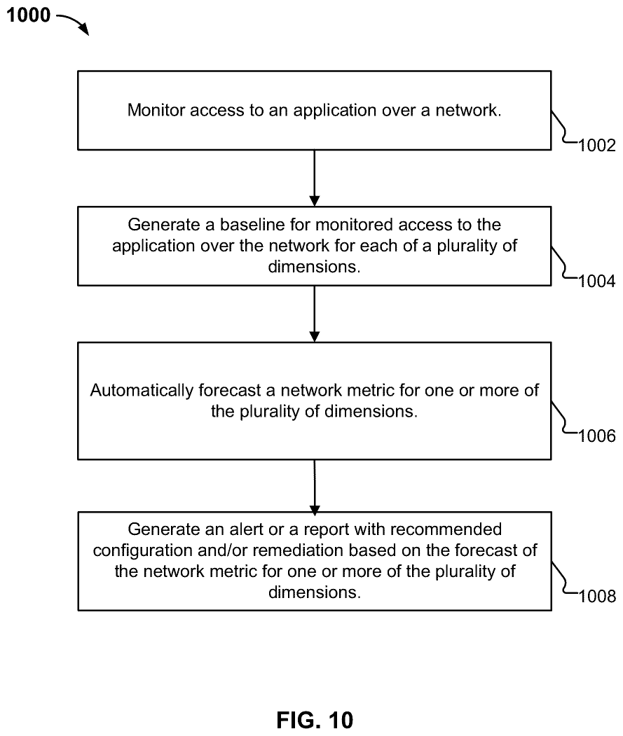

FIG. 10 is another flow diagram of a process for performing topological co-relation techniques in accordance with some embodiments. In some embodiments, a process 1000 as shown in FIG. 10 is performed by the disclosed techniques as similarly described above including the embodiments described above with respect to FIGS. 4A-7B.

At 1002, access to an application over a network (e.g., for the specified user or group of users) is monitored, as similarly described above with respect to FIGS. 4A-7B.

At 1004, a baseline for monitored access to the application over the network for each of a plurality of dimensions is generated, such as similarly described above with respect to FIGS. 4A-7B.

At 1006, a network metric is automatically forecasted for one or more of the plurality of dimensions, such as similarly described above with respect to FIGS. 4A-8C. In one embodiment, ML prediction/forecasting for capacity can be performed using the above-described AIOPs platform/solution to predict/forecast various network capacity and/or other access related issues. As an example, the AIOPs platform can be used to recommend adding network capacity for a given network for access to a Private/SaaS App based on a prediction that the customer will exceed their current capacity in 30 days. As another example, the AIOPs platform can be used to identify a masquerading user based on detecting impermissible time travel (e.g., a user logs into the SASE/PrismaAccess from two different source locations/ISPs that would be unlikely within a given period of time based on a geographical distance associated with the two different source locations/ISPs, as such can be detected as anomalous user activity and an appropriate mediation response can be recommended or automatically performed, such as to quarantine the user to prevent access to sensitive information/resources for the customer/enterprise).

At 1008, an alert or a report is generated with a recommended configuration and/or remediation based on the forecast of the network metric for one or more of the plurality of dimensions, such as similarly described above with respect to FIGS. 4A-7B.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
derive hop-by-hop metrics for a network topology and a plurality of events for a cloud-based security service associated with access to an application over a network for a user or a group of users, wherein the network topology is monitored dynamically;
correlate the derived hop-by-hop metrics and the plurality of events on a plurality of dimensions to facilitate automatically determining a root cause of an issue associated with the access to the application over the network for the user or the group of users based on the plurality of events; and
perform a remediation response based on the root cause of the issue associated with the access to the application over the network for the user or the group of users based on the plurality of events; and
a memory coupled to the processor and configured to provide the processor with instructions.

2. The system of claim 1, wherein the root cause of the issue associated with the access to the application over the network for the user or the group of users is determined by using topological co-relation for correlating a plurality of data sources across a plurality of domains using artificial intelligence and/or machine learning.

3. The system of claim 1, wherein the root cause of the issue associated with the access to the application over the network for the user or the group of users is determined by using topological co-relation for correlating a plurality of data sources across a plurality of domains using artificial intelligence and/or machine learning, and wherein the plurality of domains includes network, authentication, DNS, SaaS/Private App health, and security policy configuration.

4. The system of claim 1, wherein the root cause of the issue associated with the access to the application over the network for the user or the group of users is determined to be associated with an anomaly in network connectivity and/or a performance degradation associated with the access to the application over the network for the user or the group of users.

5. The system of claim 1, wherein the remediation response includes generating a human consumable and actionable verdict analysis that reduces a mean time to detect and remediate application connectivity issues.

6. The system of claim 1, wherein the automatically determining the root cause of the issue associated with the access to the application over the network for the user includes identifying a network infrastructure issue, a customer network services issue, a client connectivity issue, SaaS/private application (app) health issue, and/or other connectivity/reachability issue or performance degradation issue.

7. The system of claim 1, wherein the processor is further configured to:
automatically discover the network topology that is used by the user or the group of users to access the application to facilitate topological co-relation for root cause analysis.

8. The system of claim 1, wherein the processor is further configured to:
generate a security posture evaluation by building a unified logical model of computation for security policies associated with an enterprise network.

9. The system of claim 1, wherein the processor is further configured to:
process a user query using a natural language query interface associated with the access to the application over the network for the user or the group of users.

10. A method, comprising:
deriving hop-by-hop metrics for a network topology and a plurality of events for a cloud-based security service associated with access to an application over a network for a user or a group of users, wherein the network topology is monitored dynamically;
correlating the derived hop-by-hop metrics and the plurality of events on a plurality of dimensions to facilitate automatically determining a root cause of an issue associated with the access to the application over the network for the user or the group of users based on the plurality of events; and
performing a remediation response based on the root cause of the issue associated with the access to the application over the network for the user or the group of users based on the plurality of events.

11. The method of claim 10, wherein the root cause of the issue associated with the access to the application over the network for the user or the group of users is determined by using topological co-relation for correlating a plurality of data sources across a plurality of domains using artificial intelligence and/or machine learning.

12. The method of claim 10, wherein the root cause of the issue associated with the access to the application over the network for the user or the group of users is determined by using topological co-relation for correlating a plurality of data sources across a plurality of domains using artificial intelligence and/or machine learning, and wherein the plurality of domains includes network, authentication, DNS, SaaS/Private App health, and security policy configuration.

13. The method of claim 10, wherein the remediation response includes generating a human consumable and actionable verdict analysis that reduces a mean time to detect and remediate application connectivity issues.

14. The method of claim 10, wherein the automatically determining the root cause of the issue associated with the access to the application over the network for the user includes identifying a network infrastructure issue, a customer network services issue, a client connectivity issue, SaaS/private application (app) health issue, and/or other connectivity/reachability issue or performance degradation issue.

15. The method of claim 10, wherein the root cause of the issue associated with the access to the application over the network for the user or the group of users is determined to be associated with an anomaly in network connectivity and/or a performance degradation associated with the access to the application over the network for the user or the group of users.

16. The method of claim 10, further comprising:
automatically discovering the network topology that is used by the user or the group of users to access the application to facilitate topological co-relation for root cause analysis.

17. The method of claim 10, further comprising:
generating a security posture evaluation by building a unified logical model of computation for security policies associated with an enterprise network.

18. The method of claim 10, further comprising:
processing a user query using a natural language query interface associated with the access to the application over the network for the user or the group of users.

19. A computer program product embodied in a non-transitory computer readable medium and comprising computer instructions for:
deriving hop-by-hop metrics for a network topology and a plurality of events for a cloud-based security service associated with access to an application over a network for a user or a group of users, wherein the network topology is monitored dynamically;
correlating the derived hop-by-hop metrics and the plurality of events on a plurality of dimensions to facilitate automatically determining a root cause of an issue associated with the access to the application over the network for the user or the group of users based on the plurality of events; and
performing a remediation response based on the root cause of the issue associated with the access to the application over the network for the user or the group of users based on the plurality of events.

20. A system, comprising:
a processor configured to:
monitor access to an application over a network;
generate a baseline for the monitored access to the application over the network for each of a plurality of dimensions;
automatically forecast a network metric for one or more of the plurality of dimensions; and
generate an alert or a report with recommended configuration and/or remediation based on the forecast of the network metric for the one or more of the plurality of dimensions; and
a memory coupled to the processor and configured to provide the processor with instructions.
